(19) United States
(12) Patent Application Publication
(10) Pub. No.: US 2026/0111074 A1
(43) Pub. Date: Apr. 23, 2026

(54) Systems and Methods for Processing Data Involving Aspects of Brain Computer Interface (BCI), Virtual Environment and/or other Features Associated with Activity and/or State of a User's Mind, Brain and/or other Interactions with the Environment

(71) Applicant: MindPortal Inc., San Francisco, CA (US)

(72) Inventors: Jack Baber, London (GB); Ekram Alam, London (GB)

(73) Assignee: MindPortal Inc., San Francisco, CA (US)

(21) Appl. No.: 19/330,741

(22) Filed: Sep. 16, 2025

Related U.S. Application Data
(63) Continuation of application No. PCT/US2024/020479, filed on Mar. 18, 2024.
(60) Provisional application No. 63/452,679, filed on Mar. 16, 2023.
(60) Provisional application No. 63/453,056, filed on Mar. 17, 2023.
(60) Provisional application No. 63/453,155, filed on Mar. 19, 2023.
(60) Provisional application No. 63/453,457, filed on Mar. 20, 2023.
(60) Provisional application No. 63/454,058, filed on Mar. 23, 2023.

(51) Int. Cl. G06F 3/01

(52) U.S. Cl. CPC G06F 3/015; G06F 3/013; G06F 2203/011

(57) ABSTRACT

Systems and methods associated with mind/brain-computer interfaces are disclosed. Certain implementations may include or involve processes of collecting and processing brain activity data, such as those associated with the use of a brain-computer interface that enables, for example, decoding and/or encoding a user's brain functioning, neural activities, and/or activity patterns associated with thoughts, including sensory-based thoughts, determining user attention and/or intentions during interactions within virtual environment and in other applications. Consistent with various aspects of the disclosed technology, systems and methods herein include and/or involve features and functionality enabling hands-free selection of UI elements in virtual environment or on other media.

### CROSS-REFERENCE TO AND INCORPORATION OF RELATED APPLICATIONS INFORMATION

This is a (bypass) continuation of PCT International Application No. PCT/US2024/020479, filed Mar. 18, 2024, published as WO 2024/192445A1, and claims benefit of/priority to U.S. provisional patent application Nos. 63/452,679, filed Mar. 16, 2023, 63/453,056, filed Mar. 17, 2023, 63/453,155, filed Mar. 19, 2023, 63/453,457, filed Mar. 20, 2023, and 63/454,058, filed Mar. 23, 2023, all of which are incorporated herein by reference in entirety.

### DESCRIPTION OF RELATED INFORMATION

Some challenges in the general field of brain-computer interfaces relate to absences of and/or problems with options that are one or both of non-invasive and/or effective with regard to the interfaces utilized, the interactions involved, the models, interpretations and/or processing used to analyze brain and/or user activity, and/or the outputs desired. In regard to some applications, for example, existing brain-interfaces don't provide solutions for efficiently and fluidly interacting with user-interfaces, operating on a real-time basis, requiring users to do counter-intuitive things, processing data, providing results and/or outputs of sufficient quality, among a host of other drawbacks.

Among other such drawbacks in certain embodiments, for example, existing brain interfaces are rudimentary in nature and do not enable users to directly interact with machines in a natural and high-bandwidth way. Humans naturally use speech to communicate with others as well as computers and humans naturally imagine commands, potential actions, and desires in our own minds using internal/imagined speech. Brain-computer interface that can directly decode our imagined, intended speech would have massive impact on the field and across various industries. Instead of using keyboards, individuals simply think thoughts and directly have brain data translated to text. Instead of using controllers in virtual or artificial reality, users think of language commands to interface with the spatial software. In patients with disabilities and who have lost the ability to communicate, such technology may give them unrestricted capacity to communicate. Further, such innovations can be used across industries.

At present, Electrocorticography (ECOG), an invasive surgically implanted array of electrodes, has been demonstrated to be capable of reconstructing imagined speech with word-to-word reconstruction, albeit with a limited vocabulary of words. However, it is highly desirable to enable non-invasive decoding of continuous imagined speech, so that the capability is available to everyone and is much more widely accessible. In addition, the added benefit of being able to collect vast quantities of data with non-invasive systems offers the opportunity to leverage modern artificial intelligence algorithms more effectively and broaden the vocabulary, capabilities and robustness of the system.

### Overview of Some Aspects of the Disclosed Technology

One or more aspects of the present disclosure generally relate to improved computer-based systems, wearable devices, methods, platforms and/or user interfaces, and/or combinations thereof, and particularly to, improved computer-based systems, wearable devices, hardware architectures, methods, signal and other computer processing, platforms and/or user interfaces associated with mind/brain-computer interfaces that are driven by various technical features and functionality, including laser/optical-based brain signal acquisition, decoding modalities, encoding modalities, brain-computer interfacing, virtual reality (VR)/extended reality (XR)/augmented reality (AR)/mixed reality (i.e., “artificial reality” or “altered reality”) environments and/or content interaction, signal processing, and motion artefact reduction, among other features and functionality set forth herein. Aspects of the disclosed technology and platforms here may comprise and/or involve processes of collecting and processing brain activity data, such as those associated with the use of a brain-computer interface that enables, for example, decoding and/or encoding a user's brain/neural activities/activity patterns associated with thoughts such as those involving all types of senses (e.g., vision, language, movement, touch, smell functionality, sound, etc.), and the like. Systems and methods herein may include and/or involve the leveraging of innovative brain-computer interface aspects and/or associated user environments, non-invasive wearable or portable devices and/or systems to facilitate and enhance user interactions and which provide technical outputs, solutions and results, such as those required for or associated with next generation wearable devices, controllers, and/or other computing components based on human thought/brain/mind signal detection and processing and/or computer processing and interaction.

As set forth in the various illustrative embodiments described below, the present disclosure provides exemplary technically improved computer-based processes, systems and computer readable media. In some implementations, such innovations may be associated with and/or involve a brain-computer interface based platform that decodes and/or encodes neural activities associated with thoughts (e.g., human thoughts, etc.), user motions, and/or brain activity based on signals gathered from location(s) where brain-detection optodes are placed, which may operate in modalities such as vision, speech, sound, gesture, movement, actuation, touch, smell, and the like. According to some embodiments, the disclosed technology may include or involve process for detecting, collecting, recording, and/or analyzing brain signal activity, and/or generating output(s) and/or instructions regarding various data and/or data patterns associated with various neural activities/activity patterns, all via a non-invasive brain-computer interface platform. Empowered by the improvements set forth in the wearable and associated hardware, optodes, etc. herein, as well as its various improved aspects of data acquisition/processing set forth below, aspects of the disclosed brain-computer interface technology achieve high resolution, portability, and/or enhanced volume in terms of data collecting ability, among other benefits and advantages. These systems and methods leverage numerous technological solutions and their combinations to create a novel brain-computer interface platform, wearable devices, and/or other innovations that facilitate mind/brain computer interactions to provide specialized, computer-implemented functionality, such as optical modules (e.g., with optodes, etc.), thought detection and processing, limb movement decoding, whole body continuous movement decoding, AR and/or VR content interaction, direct movement goal decoding, direct imagined speech decoding, touch sensation decoding, and the like.

Some other aspects of the disclosed technology describe systems and methods for using non-invasive instrumentation such as high-density diffuse optical tomography (HD-DOT) or other optical systems such as conventional multichannel near-infrared spectroscopy (either continuous wave, frequency-domain or time-domain) to enable direct continuous speech decoding. Rather than use word to word reconstruction, the systems and methods herein may utilize, involve and/or demonstrate semantic level decoding. In other words, the HD-DOT implementations herein may detect haemodynamic patterns of activity in the user's brain when they are listening to stories, words or passages of text or while imagining words, stories or passages of text. Systems and methods herein may then compare this brain data to the information being listened to or imagined in order to enable a brain-data-to-semantic-information-representation matching. Systems and methods described herein may then extract semantic information (i.e., meaning-level information, etc.) directly from brain data. In some embodiments, the systems and methods herein may utilize generative artificial intelligence to reconstruct passages of text or language that approximate the semantic meaning decoded from the brain data.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1A is a diagram illustrating one exemplary process decoding neural activities associated with human thoughts of manifesting sensory modalities, consistent with exemplary aspects of certain embodiments of the present disclosure.

FIG. 1B is a diagram illustrating one exemplary BCI configured with exemplary features, consistent with exemplary aspects of certain embodiments of the present disclosure.

FIG. 2 depicts various exemplary aspects/principles involving detecting neural activities, consistent with exemplary aspects of certain embodiments of the present disclosure.

FIG. 3 depicts other exemplary aspects/processes involving detecting neural activities, consistent with exemplary aspects of certain embodiments of the present disclosure.

FIGS. 4A-4D are diagram illustrating one exemplary wearable BCI device and system, consistent with exemplary aspects of certain embodiments of the present disclosure.

FIGS. 5A-5B depict two illustrative implementations including components associated with the combined VR and eye tracking hardware and EEG measuring BCI hardware, consistent with various exemplary aspects of one or more implementations of the disclosed technology.

FIGS. 6A-6B depict two illustrative implementations including exemplary optode and electrode placement aspects associated with certain exemplary BCI hardware, consistent with various exemplary aspects of one or more implementations of the disclosed technology.

FIGS. 7A-7B depict exemplary process flows associated with processing brain data and eye tracking data and converting the data to compressed images in the latent space, consistent with various exemplary aspects of one or more implementations of the disclosed technology.

FIG. 8 depicts an exemplary flow diagram associated with processing compressed images from the latent space as well as creation of a generator/discriminator network for comparison of brain signal (e.g., EEG, etc.) generated versus eye tracking actual visual saliency maps, consistent with various exemplary aspects of one or more implementations of the disclosed technology.

FIG. 9 depicts an exemplary user interface generated by a VR headset, consistent with various exemplary aspects of one or more implementations of the disclosed technology.

FIG. 10 depicts an illustrative flow diagram detailing one exemplary process of using a VR (and/or other) headset in combination with a BCI to create and compare a ground truth visual saliency map with a BCI-EEG generated visual saliency map, consistent with various exemplary aspects of one or more implementations of the disclosed technology.

FIG. 11 depicts an exemplary flow diagram illustrating utilization of brain state assessment features during an artificial reality experience in connection with updating the experience, consistent with various exemplary aspects of one or more implementations of the disclosed technology.

FIGS. 12A-12B depict examples of illustrative data visualizations, e.g., such as those that may automatically displayed/shown to represent the user's brain state in a user-friendly way, consistent with various exemplary aspects of one or more implementations of the disclosed technology.

FIG. 13 depicts an exemplary flow diagram illustrating combined eye-tracking and brain data timestamping for use in brain state assessment in an Artificial reality experience, consistent with various exemplary aspects of one or more implementations of the disclosed technology.

FIG. 14 depicts an exemplary advanced decoder for ‘no-pre-task’ mental state decoding using automatic channel selection mechanisms, consistent with various exemplary aspects of one or more implementations of the disclosed technology.

FIGS. 15A-15B depict exemplary implementations comprised of brain computer interface systems and mixed reality systems integrated together, consistent with various exemplary aspects of one or more implementations of the disclosed technology.

FIG. 16 depicts an exemplary feedback loop between an integrated brain computer interface system and a mixed reality system, consistent with various exemplary aspects of one or more implementations of the disclosed technology.

FIG. 17 depicts an exemplary flow diagram illustrating aspects associated with combining data streams from the integrated brain computer interface and the mixed reality system as well as associated analysis of event-related brain data, consistent with various exemplary aspects of one or more implementations of the disclosed technology.

FIG. 18 depicts an exemplary flow diagram illustrating aspects associated with combining the data streams as well as decoding the user's attention and/or intention in the artificial reality experience, consistent with various exemplary aspects of one or more implementations of the disclosed technology.

FIG. 19 depicts an exemplary flow diagram illustrating aspects relating to how the brain data may be split and processed as particular types of brain data, consistent with various exemplary aspects of one or more implementations of the disclosed technology.

FIG. 20 depicts an exemplary system and setup wherein the brain computer interface technology is integrated/integral with the structure of an extended reality (XR) wearable, consistent with various exemplary aspects of one or more implementations of the disclosed technology.

FIG. 21 depicts another exemplary system and setup wherein the integrated wearable device includes an extended area brain detection region, such as one utilized for higher density recording, consistent with various exemplary aspects of one or more implementations of the disclosed technology.

FIG. 22 depicts an exemplary system overview illustrating representative subcomponents of the integrated brain computer interface and extended reality systems, consistent with various exemplary aspects of one or more implementations of the disclosed technology.

FIG. 23 depicts an exemplary flow diagram illustrating aspects relating to usage and associated processing regarding the present high-density diffuse optical tomography (HD-DOT) brain-interface systems and methods, consistent with various exemplary aspects of one or more implementations of the disclosed technology.

FIG. 24 depicts an exemplary system and wearable setup illustrating aspects of a representative high-density diffuse optical tomography (HD-DOT) brain interface integrated into a wearable artificial reality apparatus, consistent with various exemplary aspects of one or more implementations of the disclosed technology.

FIG. 25 depicts a flowchart illustrating an exemplary signal processing chain for optical data associated with a representative high-density diffuse optical tomography (HD-DOT) brain interface, consistent with various exemplary aspects of one or more implementations of the disclosed technology.

FIGS. 26A-26C depict various exemplary aspects of brain measurement(s) and processing involving high-density diffuse optical tomography (HT-DOT) arrays and associated signals, consistent with various exemplary aspects of one or more implementations of the disclosed technology.

### DETAILED DESCRIPTION OF ILLUSTRATIVE IMPLEMENTATIONS

Systems, methods and wearable devices associated with mind/brain-computer interfaces are disclosed. Embodiments herein include features related to one or more of optical-based brain signal acquisition, decoding modalities, encoding modalities, brain-computer interfacing, artificial reality environments and/or content interaction, signal processing, signal to noise ratio enhancement, motion artefact reduction, and/or various aspects of related user intention detection, processing and/or output generation, among other features set forth herein. Certain implementations may include or involve processes of collecting and processing brain activity data, such as those associated with the use of a brain-computer interface that enables, for example, decoding and/or encoding a user's brain functioning, neural activities, and/or activity patterns associated with thoughts, including sensory-based thoughts. Further, the present systems and methods may be configured to leverage brain-computer interface and/or non-invasive wearable device aspects to provide enhanced user interactions for next-generation wearable devices, controllers, and/or other computing components based on the human thoughts, brain signals, and/or mind activity that are detected and processed. Certain underlying aspects are also set forth in co-owned PCT International publication No. WO2022/198142A1, which is incorporated herein by reference.

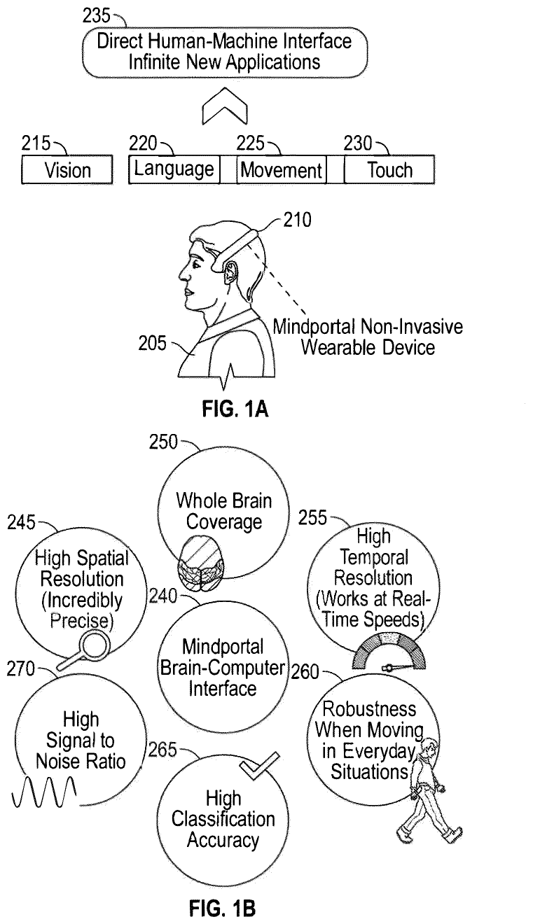

FIG. 1A is a diagram illustrating one exemplary process related to decoding neural activities associated with human thoughts involving or manifesting sensory modalities, consistent with exemplary aspects of certain embodiments of the present disclosure. In this illustrated example, a human user 205 may wear a non-invasive wearable device 210 that implements the brain computer interface (BCI) technology disclosed herein. Here, e.g., in connection with the BCI platform, device 210 may be configured to be positioned around the head/brain of the user so as to mount the scalp of the user. The BCI device 210 may also be configured to be worn in other suitable ways that do not require surgery on the user's head/brain. With the neural signals detected/collected, the BCI device 210 may directly decode those neural activities of the user's thoughts associated with all types of sensory abilities. For example, as shown herein, the neural activities may be decoded by the BCI device 210 into vision 215 (e.g., mental images, etc.), language 220 (e.g., imagined speech, etc.), movement 225, touch 230, and other sensory modalities. Empowered with the sensory data decoded from the neural activities, a variety of applications 235 may be implemented via the BSI technology disclosed herein. In some embodiments, direct human goals and software symbiosis is enabled using the present brain computer interface technology.

FIG. 1B is a diagram illustrating one exemplary brain computer interface 240 and various illustrative features, consistent with exemplary aspects of certain embodiments of the present disclosure. Here, such brain-computer interface 240 may be configured with various exemplary features and functionality such as ability to obtain neural activity data of high spatial resolution (e.g., highly precise) 245, obtain data spanning full brain coverage 250, obtain data of high temporal resolution (e.g., works at real-time speed/manner, etc.) 255, obtain data that is robust and accurate, e.g., when the user moves about in everyday situations, etc., at 260, obtain data of high classification accuracy 265, obtain data of high signal to noise ratio 270, and the like. As a result of these features and benefits, the brain-computer interface 240 may be configured to be worn by the user (or otherwise applied onto the user) in a more compelling and/or natural fashion.

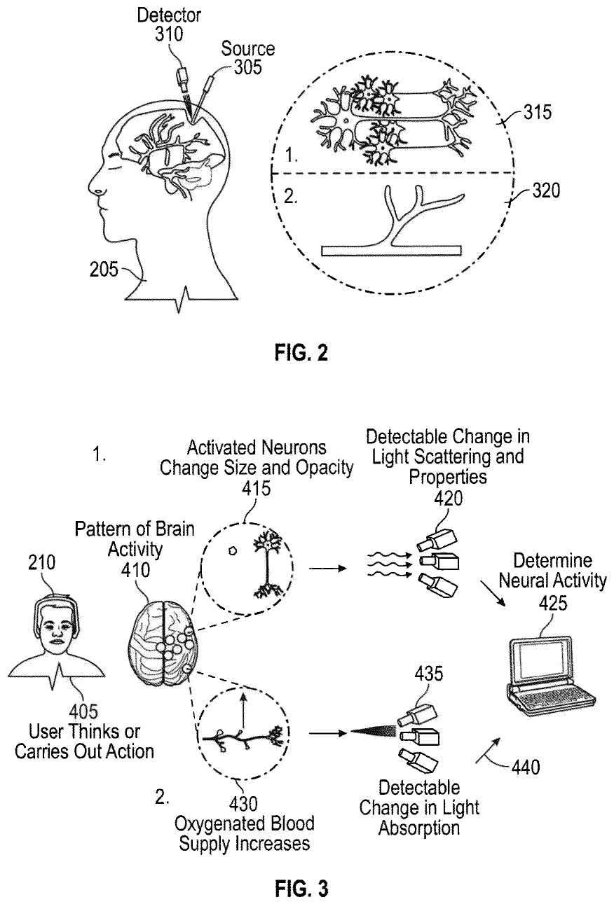

FIG. 2 depicts exemplary principles involved with detection of neural activities, consistent with exemplary aspects of certain embodiments of the disclosed technology. In this example, a non-invasive technology such as optoelectronic based technique is illustrated to implement a brain-computer interface of, for example, FIGS. 1A-1B. Here, a detector 310 and a source (e.g., an optical source, such as a laser light source, etc.) 305 are applied to the brain of the user 205. As the brain incurs neural activities (e.g., upon thoughts, including by not limited to those of senses such as an image, sound, speech, movement, touch, smell, etc., upon body movement(s), and/or upon brain activity in certain locations, etc.), different regions of neurons in the brain are “activated” as manifested in, e.g., changes in neurons themselves, changes in blood supplies to the neurons, and so on. In this example, using optical system(s) herein, brain-computer interfaces consistent with the disclosed technology may be configured to detect: 1) neuronal changes, as illustrated in the upper half circle, at 315; and/or 2) blood changes at active site of the brain, as illustrated in the lower half circle, at 320.

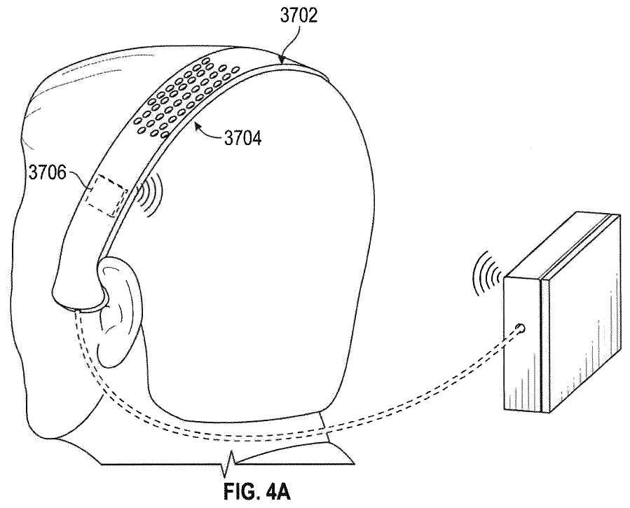

FIG. 3 is an exemplary flow diagram involving detection of neural activities, consistent with exemplary aspects of certain embodiments of the present disclosure. In this illustrated example, two pathways are shown with regard to communicate the user's thoughts to an external device. Here, the user (shown with wearable device 210) thinks or carries out an action at step 405. Upon such thoughts and/or actions, the pattern(s) of the brain activities 410 incurred are detected/collected via the brain-computer interface, at 420 and 435. Along the upper pathway, such patterns of neuron activities may be manifested in, as shown at step 415, activated neuron change in size and/or opacity, and/or other characteristics associated with a neuron activation state. As such, at step 420, the patterns of brain activities may be detected (e.g., by use of the optodes configured on device 210, etc.) via detectable changes in light scattering and/or properties caused by the afore-described changes in neurons. In this illustrative implementation, at 425, the detected signals are shown, in turn, being transmitted to an external device for further processing/application. Along the lower pathway, such patterns of neuron activities 410 may be manifested in, as shown at step 430, oxygenated blood supply increase, and/or other blood/blood vessel characteristics associated with a neuron activation state. As such, at step 435, the patterns of brain activities may be detected (e.g., by use of the optodes configured on device 210, etc.) via detectable changes in light absorption. In turn, such detected signals may then be transmitted to the external device for further processing/application, at 440. In some embodiments, the two pathways may also be reversed such that the brain-computer interface is a bi-directional and/or encoding interface that is capable of encoding signals (e.g., data, information of images, texts, sounds, movements, touches, smell, etc.) onto the user' brain to invoke thoughts/actions based thereof. In some embodiments, the BCI may be configured to achieve signal detection precision level of 5 mm cubed, but the precision (spatial resolution) can be altered so as to extract information from volumes of the brain of different volumes/sizes.

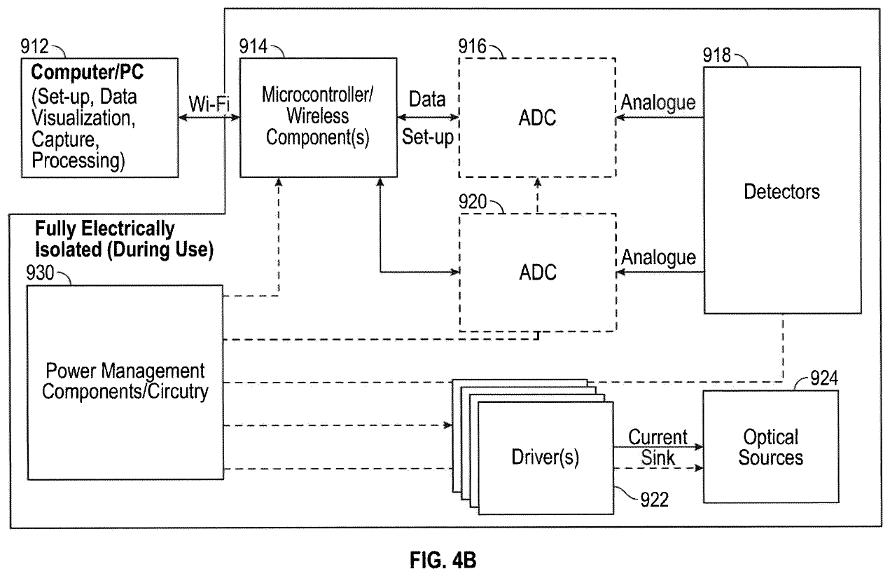

FIG. 4A is a diagram illustrating one exemplary wearable brain-computer interface device, consistent with exemplary aspects of certain embodiments of the present disclosure. As shown in this example, a wearable/portable brain-computer interface device 902 may be attached/associated and configured with respect to a user' head in a non-invasive manner. Here, one illustrative BCI device 902 is shown as mounted atop/across the user's head, with one or more brain-facing detection portions, panels or subcomponents 904 facing towards the user's brain. Of course, in other embodiments, various other systems, devices and techniques may be utilized to acquire mind/brain activity of a user, as set forth elsewhere herein. According to implementations herein, such brain-facing portions, panels or subcomponents 904 may include one or more optodes, which may each comprise: one or more sources, such as dual-wavelength sources, and/or one or more detectors, such as photodiodes (e.g., in some exemplary embodiments, with integrated TIAs, transimpedance amplifiers, etc.). Here, e.g., examples of such sources and detectors are shown and described in more detail in connection with FIGS. 4C-4D, below. In this illustrative example of FIG. 4A, the BCI device 902 may be adapted in any wearable shape or manner, including but not limited to the example embodiment shown, here, having a curved and/or head-shaped design. Here, for example, such that the wearable devices and/or subcomponents thereof (e.g., with optodes and/or comparable sources and detectors) can be adapted to adjustably fit and cover the user's head such that the desired optodes (or equivalent) are positioned over the portion(s) of the user's brain to capture the signals needed and/or of interest. In this example, the BCI device 902 may also be configured with one or more processing/computing subcomponents 906, which may be positioned or located on the wearable device itself and/or all or one or more portions thereof may be located elsewhere, physically and/or operationally/computationally, such as in a separate subcomponent and/or integrated with other computing/processing components of the disclosed technology e.g., the housing of 906 and everything within 906 may be placed on a wristband, watch, another such wearable, or other device and be connected to the remainder of the headset wirelessly, such as via Bluetooth or WiFi. Further, element 906 may be a housing which in this particular embodiment of a wearable is being used to house the wiring and the electronic circuitry shown in FIG. 4B, including components such as, e.g., the optical source drivers 922, analog to digital converters 916, 920, and microcontroller and wifi module 914.

FIG. 4B is a block diagram illustrating an exemplary brain-computer interface device, such as wearable device 902 shown in FIG. 4A and an associated computing device 912 (e.g., computer, PC, gaming console, etc.), consistent with exemplary aspects of certain embodiments of the present disclosure. As shown herein, an exemplary brain-computer interface device may comprise one or more of: one or more one optical source driver(s) 922, which may, e.g., be utilized to control the intensity, frequency and/or wavelength of the optical signals emitted by the optical sources and may also be configured, in some implementations, to set the electromagnetic energy to be emitted in continuous form or in timed pulses of various length or in other such frequency-type variation(s); at least one optical source 924 configured to emit the optical signal (e.g., light, laser, electro-magnetic energy, etc.), which, in some embodiments, may be in the near-infrared, infrared or visual range of the spectrum; one or more optional conversion components 916, 920, if/as needed, such as analog to digital and/or digital to analog converters; one or more optical detectors 918 that detect optical signals that exit the brain tissue containing information regarding the properties of the brain of the human user; at least one microcontroller and/or wifi module 914, where such microcontroller may be configured to sends control signals to activate the various components on the electronics layout and may also be configured to control the WiFi module. In some implementations, the microcontroller and/or wifi module 914 may be connected to one or more computing components 912, such as a PC, other computing device(s), gaming consoles, etc.] by one or both of a physical/hard-wire connection (e.g., USB, etc.) and/or via a wireless (e.g., WiFi, etc.) module. Further, the microcontroller and wifi module may be housed together, as shown, they may be split or distributed, and one, both or neither may be integrated with a wearable BCI device, another mobile device of the user (e.g., watch, smartphone, etc.) and/or the other computing and/or PC device(s) 912.

According to one or more embodiments, in operation, the driver(s) 922 may be configured to send a control signal to drive/activate the light sources 922 at a set intensity (e.g., energy, fluence, etc.), frequency and/or wavelength, such that optical sources 924 emit the optical signals into the brain of the human subject.

Turning next to operations associated with detection and/or handling of detected signals, in some embodiments, various processing occurs utilizing fast optical signals and/or haemodynamic measurement features, as also set forth elsewhere herein. In some embodiments, for example, one or both of such processing may be utilized, which may be carried out simultaneously (whether being performed simultaneously, time-wise, or in series but simultaneous in the sense that they are both performed during a measurement sequence) or separately from one another:

### Fast Optical Signal (FOS) Processing:

According to such fast optical signal implementations, the optical signal entering the brain tissue passes through regions of neural activity, in which changes in neuronal properties alter optical properties of brain tissue, causing the optical signal to scatter differently as a scattered signal. Further, such scattered light then serves as the optical signal that exits the brain tissue as an output signal, which is detected by the one or more detectors to be utilized as the received optical signal that is processed.

### Haemodynamic:

According to such haemodynamic implementations, first, optical signals entering brain tissue pass through regions of active blood flow near neural activity sites, at which changes in blood flow alter optical absorption properties of the brain tissue. Further, the optical signal is then absorbed to a greater/lesser extent, and, finally, the non-absorbed optical signal(s) exit brain tissue as an output signal, which is detected by the one or more detectors to be utilized as the received optical signal that is processed.

Turning to next steps or processing, the one or more detectors 918 pick-up optical signals which emerge from the human brain tissue. These optical signals may be converted, such as from analog to digital form or as otherwise needed, by one or more converters, such as one or more analog to digital converters 916, 920. Further, the resulting digital signals can be transferred to a computing component, such as a computer, PC, gaming console, etc. via the microcontroller and communication components (wireless, wired, WiFi module, etc.) for signal processing and classification.

Finally, various specific components of such exemplary wearable brain-computer interface device are also shown in the illustrative embodiment depicted in FIG. 4B, such as microcontroller/wireless component(s) 914 (which may include, e.g., a Pyboard D component), converters 916, 920 (which may include, e.g., ADS1299 ADC components), detectors 918 (which may include, e.g., an OPT101 component having photodiode with integrated TIA, etc.), optical sources (which may, e.g., include laser sources, LEDs, etc.), driver(s) 922 (which may include, e.g., one or more TLC5940 components, etc.), and a power management component, though the innovations herein are not limited to any such illustrative subcomponents.

FIGS. 4C-4D are diagrams illustrating aspects of the one or more brain-facing detection portions, panels or subcomponents 904, consistent with exemplary aspects of certain embodiments of the present disclosure. As set forth in more detail elsewhere herein, such portions, panels or subcomponents 904 may be comprised of one or more panels, which each comprise one or more optodes 928. As set forth, below, each such optode may comprise: one or more sources, such as dual-wavelength sources, and/or one or more detectors, such as photodiodes (e.g., in some exemplary embodiments, with integrated TIAs, transimpedance amplifiers, etc.), such as shown and described in more detail in connection with FIGS. 4C-4D.

Brain Computer Interface (BCI)+Artificial Reality with Eye Tracking, EEG and Other Features

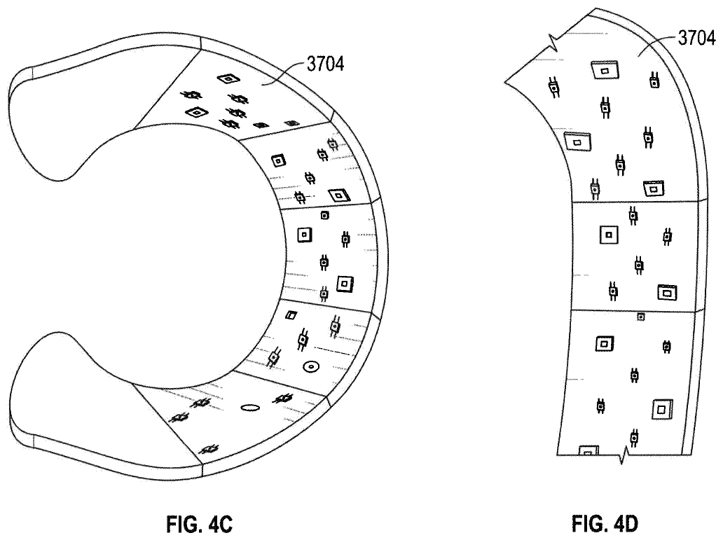

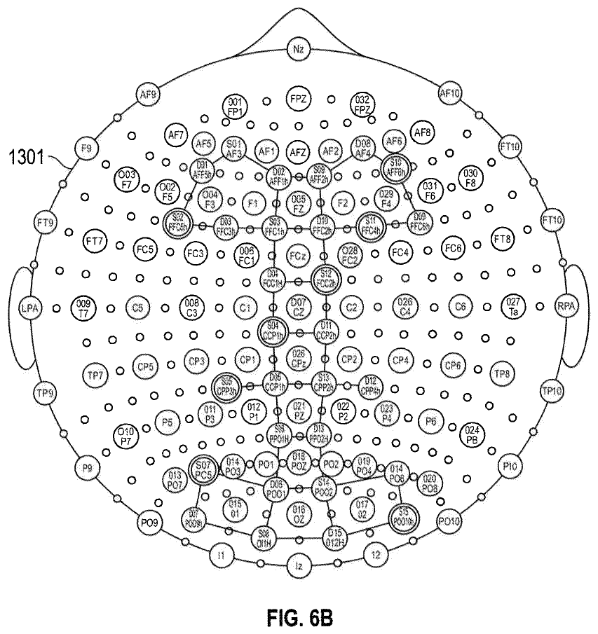

FIGS. 5A-5B depict two illustrative implementations including components associated with the combined artificial reality and user action/activity (e.g., eye tracking, etc.) hardware and brain signal (e.g., EEG measuring, etc.) BCI hardware, consistent with various exemplary aspects of one or more implementations of the disclosed technology. Turning to embodiments of the presently-disclosed inventions, here referring to FIGS. 5A-5B, a user may simultaneously wear an artificial reality headset 1202, such as a VR, XR or similar headset, in combination with the brain computer interface (BCI) 1201. Herein, while the term VR headset 1202 is used in numerous instances for the sake of convenience, it should be understood that this term refers to artificial reality headsets, such as VR headsets, XR headsets, and the like. In one illustrative embodiment, shown in FIG. 5A, the BCI and VR headset containing eye tracking hardware and software components are implemented as two separate components, such as two separate headsets. In another illustrative embodiment, shown in FIG. 5B, the BCI and VR headset containing eye tracking hardware and software components are contained within one combined headset. Other configurations and arrangements of such components may be utilized, e.g., in other embodiments. Consistent with the disclosed technology, the VR headset 1202 may further contain built in eye-tracking hardware and software components. Further, the VR headset 1202 may be arranged and configured to be capable of displaying a visual user interface, such as the exemplary visual user interface 1601 shown in FIG. 9. According to embodiments herein, the eye tracking hardware and software components of the VR headset 1202 may be utilized to measure a user's eye movement in response to the display of such visual user interface 1601. Further, the BCI 1201 may include or involve various optodes, electrodes, and/or other measurement instruments and/or functionality for the collection of EEG and other brain data, as described elsewhere herein.

In the illustrative embodiments shown in FIGS. 5A and 5B, such exemplary BCI 1201 and VR headset 1202 systems may also be connected to a computing component 1204, with the computing component 1204 operating and/or implementing software, which may be, e.g., in one embodiment, the Unity software system, but in other embodiments may include and/or involve any extended reality software system and which implements/displays an extended reality experience. In such embodiments, the BCI and VR headset components, 1201 and 1202, connected to the computing component 1204, can be used to operate a virtual, augmented, or mixed reality experimental paradigm 1206. Here, for example, in some embodiments, the BCI 1201 and corresponding measurement instruments used with the BCI acquire EEG measurements while the VR headset 1202 with eye tracking hardware and software components simultaneously acquires eye tracking data. Further, according to the experimental paradigm, such features may be utilized in training and implementing the system. For example, in some embodiments when training the user to use the system, a VR game may be played where objects appear in a random position of the field of view. Here and otherwise, according to aspects of the disclosed technology, associated EEG signal data and eye position data may be detected and synchronously registered onto the connected computing components 1204 of the system.

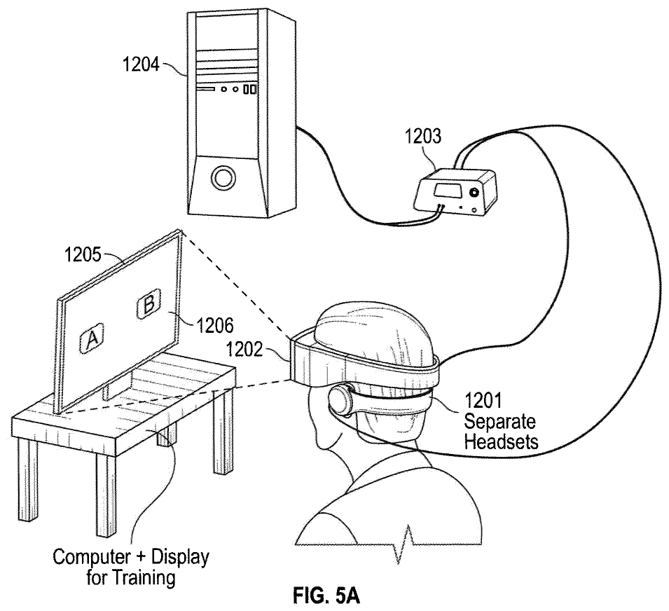

FIG. 6A depicts one illustrative electrode and optode arrangement or montage that may be utilized, e.g., in an exemplary implementation in which XR, VR, etc. eye-tracking information is involved, and such montage may comprise 36 channels, 68 optodes, 15 sources, 21 detectors, and 8 S.D. detectors. FIG. 6B depicts another illustrative electrode and optode arrangement or montage that may be utilized, e.g., in an exemplary implementation in which no XR, VR, etc. eye-tracking information is involved, and such montage may comprise 48 channels, 70 optodes, 15 sources, 23 detectors, and 8 S.D. detectors. Other quantities and ranges of such components may also be utilized, in various differing embodiments. Herein, while this one style or representation of the electrodes and optodes is depicted, other arrangements, configurations and/or illustrations of signal detection and acquisition hardware may also be used consistent with the inventions herein, such as those used by various organization affiliated with the study of the brain and/or sleep. According to other embodiments consistent with the disclosed technology, an electrode/optode arrangement may use some or all of the known 10/20 EEG system electrode/optode positioning, such as that of the 10/20 EEG placement described by the European Respiratory Society (ERS). Still other electrode and optode arrangements that provide suitable signals may also be utilized. The 10/20 EEG positioning is noted, as this is a standard arrangement used when recording brain data, particularly when recording using EEG devices. It is further noted that such 10/20 positioning, and other such electrode/optode placements, may be utilized in certain embodiments of the disclosed technology and inventions herein.

Referring to FIGS. 6A-6B, the illustrated montages of electrode and optode positions were specifically engineered to provide superior coverage/results regarding the brain activity most pertinent to aspects of the innovations herein, such as yielding accurate visual attention and saliency map determinations. According to various embodiments herein, for example, there is a denser clustering of sensors over some of the visual cortical areas of the brain including the primary visual (striate) cortex, the prestriate cortex and posterior parietal regions of the brain. Such montage positions may comprise optodes arranged to capture the optical data, as described above, and electrodes to capture specified EEG data, e.g., such as an array (ntrials×nchannels×nsamples) as explained further below. The exemplary sensor and detector locations of FIGS. 6A-6B are configured for utilization of EEG and Optical equipment for NIRS and fast optical signal processing. The exemplary sensor and detector montages of FIGS. 6A-6B are specific arrangements developed explicitly for this visual attention paradigm, with an emphasis on visual cortical areas. Additionally, these embodiments describe multimodal relationships, i.e., so they illustrate both EEG (electrodes) and optical detector locations for simultaneous measurements. Further, it is noted here that, while certain exemplary configurations of electrode and optode arrangements are shown in FIGS. 6A-6B, various other possible electrode and optode arrangements may be implemented to function in a same way to yield similar results. Among a variety of such alternative arrangements, for example, various electrodes (both dry and wet electrodes) and near-infrared optodes may be utilized in a regular arrangement purely over the visual cortex of the participant, removing any data acquired from other brain regions. As one further example of such alternative arrangements, systems and methods involving active channel selection may be utilized, whereby brain data is recorded in a standard arrangement such as 10/20 system EEG arrangement, and then the channels which best contribute to an accurate saliency map in training can be selected automatically via an algorithm, e.g., based on each channel's weighted contribution to the accurate parts of the saliency map.

According to certain embodiments, the VR headset is capable of generating a stimulus presentation 1205 to create trials for data collection utilizing both the BCI and VR headsets. Here, for example, such stimulus presentation 1205 may include, but is not limited to, the presentation of visual stimulus in the form of flashes of light and alternating light and colors across the VR headset 1206. The EEG signal data captured by the BCI 1201 and the visual data captured by the VR headset 1202 are both captured and synchronously registered in specified windows of time surrounding each visual stimulus event produced by the VR headset 1202. In one embodiment, the window of data collection and registration occurs beginning one second before the visual stimulus event and extending three seconds after the disappearance of the visual stimulus. In other embodiments, the window for data capturing may be at other intervals to acquire more or less data surrounding a visual event.

According to some embodiments, the raw EEG data may be captured and configured as an array formatted as comprising the number of trials (N₁) by the number of channels (N₂) by the number of samples (N₃). Further, in one exemplary implementation, the images of data may then be encoded into data streams from the BCI 1201 and VR headset 1202 eye tracking hardware and software components to the computing component 1204 using a variational autoencoder (VAE) 1203. In embodiments here, a variational autoencoder 1203 may be utilized because there is not always a one-to-one relationship between brain activity and the user's attention in a visual saliency map, in other words there may occur a different brain activation time for each event but can correspond to the same task. Using a variational autoencoder 1203 allows for estimating the distribution (characterized by the mean and the standard deviation) of the latent space 1407, meaning the apparatus can be used to study the relationship between the distribution of brain activations rather than just a one-to-one relationship between the latent vectors. Each sample of raw brain data is converted to images in the format as [n trials×n down×h×w].

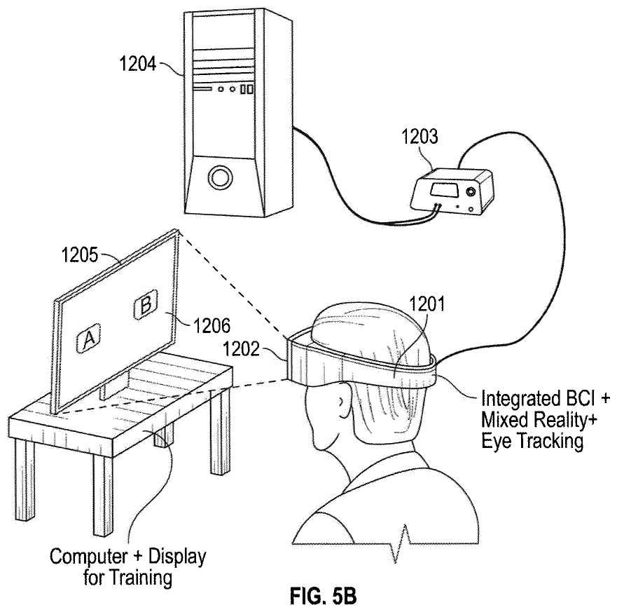

FIGS. 7A-7B depict exemplary process flows associated with processing brain data and eye tracking data and converting the data to compressed images in the latent space, consistent with various exemplary aspects of one or more implementations of the disclosed technology. Referring first to the process map in FIG. 7A, the variational autoencoder 1203 encodes both the BCI data 1401 and the VR eye tracking data 1404 from the BCI 1201 user interface and the VR headset 1202 user interface to the computing component 1204 in latent space 1407. Latent space 1407 is a theoretical representation of the process of transforming and compressing the raw data (from the BCI 1401, and from the VR headset 1404) output from the BCI 1201 and VR headset 1202, to the images in a specified format, or the Representations in the Latent Space 1 and 2 (1403 and 1406 respectively). In other embodiments, the images generated may be in a format other than the format specified above, where such other data image formats are equivalent, e.g., function in a same way and/or achieve similar result as the formats specified above. Here, for example, with recent demands of deep learning applications, synthetic data have the potential to become a vital component in the training pipeline. As a result, a multitude of image synthesis methods now exist which can be implemented with or involved in particular brain-computer interfacing contexts of the present inventions. Further, various of these image synthesis methods have not been applied to brain data previously, though due, e.g., to the capability to transform the data into conventional computational forms such as matrices and vectors in some cases, such image synthesis methods are applicable in the instant brain-computer interfacing contexts and would represent novel usage.

Similarly, while the present embodiment specifies using a variational autoencoder 1203 to encode the data streams, 1401 and 1404, other encoders or comparable hardware and/or software can be used to encode the data received from the BCI 1201 and VR headset 1202 eye tracking hardware and software components. Among other options, for example, in the place of a variational autoencoder, a generative adversarial network (GAN) may be utilized to synthesize image data directly from the eye-tracking data and then use another GAN to synthesize the brain data derived saliency map consistent with the inventions described herein. In still other embodiments, a diffusion method and/or a transformer may also be utilized.

In addition, there are a number of data augmentation techniques which can subsequently be applied to the synthetic image data to enlarge the dataset and potentially improve the accuracy of the discriminator, including but not limited to flips, translations, scale increases or decreases, rotations, crops, addition of Gaussian noise, and use of conditional GANs to alter the style of the generated image.

In still other implementations, brain data other than EEG may be utilized consistent with systems and methods of the disclosed technology, e.g., to provide similar or comparable functionality and/or similar results. Examples of other brain data that may be utilized, here, include NIRS, FOS, and combined EEG.

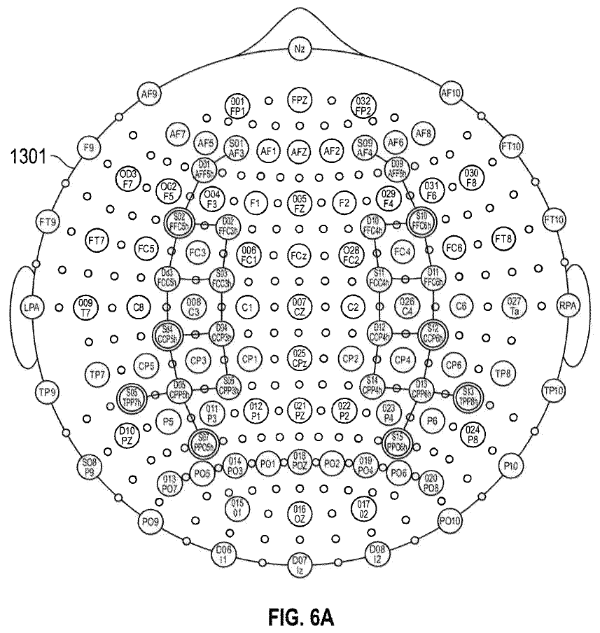

FIG. 8 depicts an exemplary process flow associated with processing compressed images from the latent space as well as creation of a generator network and/or discriminator network for comparison of EEG generated versus eye tracking actual visual saliency maps, consistent with various exemplary aspects of one or more implementations of the disclosed technology. Referring to the exemplary process flow or map shown in FIG. 8, EEG brain data images 1501 are generated from the raw brain data 1401 features obtained (as encoded and compressed by the variational autoencoder 1203, in some embodiments), based on the spatial location of the features, optodes, or electrodes on the user's head. Consistent with the innovations herein, autoencoding of the saliency map from the brain data may be achieved, inter alia, via a four-part process:

1. Constructing Images from Raw Brain Data Via Spatial Location of Features on the User's Head

According to aspects of the disclosed technology, generation of such brain data images 1501 may be accomplished by creating an array of data from multiple trials (e.g., via creation of a visual or other stimulus 1206 by the VR headset 1202, shown in FIGS. 5A-5B), then organizing each trial data set by electrode number, and by time. The trial data sets may be organized in other ways, as well, consistent with the innovations herein. According to certain systems and methods herein, the data may be additionally processed to obtain the desired/pertinent signals. In some embodiments, for example, a low-pass filter and/or down sampling can be applied to the data, such as through the variational autoencoder and/or other computing components, to extract just the pertinent signals, while excluding the artifacts or unwanted data. Further, the data may preprocessed using the computing components to remove the remaining noise and artifacts, or unwanted data. The data may then be represented on a two-dimensional map, such as via utilization of an azimuthal projection calculation. Next, in some implementations, the data may be represented as a continuous stream of data through bicubic interpolation, and this process may be repeated for all data samples collected by trial and separated by electrode location. In accordance with such aspects, the data stream created through bicubic interpolation and subsequent projection onto a two-dimensional map through azimuthal projection is then concatenated from each sample to produce an image with the number of channels corresponding to the number of temporal samples after down-sampling the signals. Finally, a process or step of normalizing the data may then be performed, e.g., after such image generation and down-sampling is performed.

Note that the above-described features represent only one exemplary methodology regarding taking and processing the raw data from the BCI 1401 and representing such data in a two-dimensional map. Other methods may be used to represent the raw data in a two-dimensional map and may be utilized to achieve the desired result(s), here, consistent with the disclosed technology. Among other things, e.g., calculations other than a bicubic interpolation may be used to interpolate the data, projections other than an azimuth projection may be used to map the signal data, and/or filtering and down sampling are ways to exclude unwanted data though are not necessary to achieve the result(s) or they may be achieved in a consonant way.

In certain embodiments herein, a random signal following a Gaussian distribution of zero mean or average and a standard deviation of 0.25 can be added to the filtering and image creation model to increase the model's stability and to better filter between noise and EEG signals. Further, according to some implementations, the use of an image format leads to better results when using convolutional networks than when using a simple array representation of the brain data, but the use of simple array representations of brain data may still be utilized, in various instances, to achieve desired results consistent with the innovations herein.

### 2. Processing EEG Images (e.g., Through a VAE) to Represent in Sub Space

As can be seen, in part, in FIG. 7B, a process of utilizing or involving a variational autoencoder 1203 to encode and filter eye tracking data 1404 may be performed to create a saliency map 1405 represented in the latent space 1407 derived from the eye-tracking data 1404. According to implementations, here, the raw eye-tracking data 1404 may first be converted to a saliency map 1405 of the user's attention using existing methods (e.g., while watching something, one can extract saliency features representing the degree of attention and average position of the center of interest in the video). Then, a variational autoencoder 1203 may be applied to recreate the saliency images or map representations of the images 1406 in latent space 1407. For example, using e.g. a raw eye tracker in some instances, one can create a visual saliency map representing the area of attention in an image of one channel with values between 0 and 1 representing the degree of visual attention on specific pixels and their neighbors. As such, the data and corresponding value between 0 and 1 can also be considered as a probability for a given pixel to be watched or not. Accordingly, visual saliency images 1405 as representations 1406 in the latent space 1407 are thus generated.

### 3. Generation of Visual Saliency Images

Next, various exemplary aspects of illustrative embodiments are described. Here, for example, in some implementations, the VR eye tracking and EEG data and resulting two-dimensional maps may be generated and/or recorded simultaneously. Further, discrete VR eye tracking measurements may be projected on two-dimensional images (e.g., one per trial). According to certain aspects, accuracy may be taken into account using circles of radius proportional to error rate. Further, in some instances, Gaussian filtering may be applied with kernel size corresponding to the eye-tracker field of view, to improve output/results.

### 4. Representing the Images in Lower Sub Space

Once the saliency images have been generated, the images may be represented in a lower sub space. Here, for example, in some embodiments, a variational autoencoder may be trained to represent the images in a lower sub space. In one illustrative embodiment, for example, a ResNet architecture may be utilized, though in other embodiments similar software and/or other programming may be used. Here, e.g., in this illustrative implementation, for the encoding section, four (4) stacks of ResNet may be used, each with 3 conversion layers and batch norm separated by a max pooling operation, though other quantities of such elements may be utilized in other embodiments. Further, in such illustrative implementations, in a decoding section, the same architecture may be utilized though with an up-sampling layer instead of a max-pooling operation. Moreover, regardless of the exact architecture, an objective of such autoencoding saliency map network is to recreate an image as close as possible to the original saliency map with a representation in shorter latent space. Additionally, in some embodiments, the latent space should be continuous, without favoring one dimension over another. Finally, in one or more further/optional embodiments, data augmentation techniques may be implemented or applied to avoid overfitting of the variational autoencoder.

FIG. 8 depicts an exemplary flow diagram associated with processing compressed images from the latent space as well as creation of a generator/discriminator network for comparison of EEG generated versus eye tracking actual visual saliency maps, consistent with various exemplary aspects of one or more implementations of the disclosed technology. As shown in part via the process map of FIG. 8, in some embodiments, e.g., after the generation of both the EEG two-dimensional map 1403 and the eye tracking data visual saliency map 1406, a generator/discriminator adversarial network (GAN) 1502 for producing the brain data derived saliency map 1503 may be implemented.

FIG. 8 illustrates an exemplary GAN 1500, which combines the EEG/brain data latent space with the saliency latent space derived from two VAEs, e.g., such as described above. However, here it is also noted that there are various other possible approaches to map the latent spaces consistent with the disclosed technology. Here, according to the disclosed technology, a goal is to map the 2 distributions (e.g., the map from the eye-tracking and the map from the EEG signals in the illustrated example). Consistent with certain embodiments, an aim is to create a model permitting the estimation of a saliency map from EEG without considering a 1:1 correspondence between modalities.

Referring to the example embodiment of FIG. 8, such GAN implementation may achieve the desired objective(s) via use of various aspects and features. For example, implementations herein may utilize a generator or generator network 1502 to recreate the image latent representation from EEG latent representation. In the example generator model shown and described, here, the generator may be created/implemented by concatenating the two parts of the VAE and linking them with fully connected layers, e.g., CNN (convolutional neural network) layers, etc. Further, a discriminator or discriminator network 1504 may be utilized to distinguish the images derived from the generator (e.g., in this illustration, as generated from the EEG representation which was in turn generated by the encoding and decoding part of the VAE) and those that are just derived from the eyetracking VAE. According to some embodiments, noise following a normal-centered distribution may be concatenated to the latent vector at the center of the generator. Overall, in the example shown in FIG. 8, the generator 1502 may perform the concatenation of the encoding part of the EEG VAE and decoding part of saliency VAE through a generator composed of fully connected layers.

Additionally, as shown in FIG. 8, a discriminator 1504 is then placed at the end of the model. Here, for example, such discriminator 1504 may then process the output(s) of the generator 1502 and discern whether the saliency maps are derived from the model (synthetic) or from the real-time eye-tracking recordation.

Importantly, it is also noted that other methods besides adversarial methods or processing (i.e., other than GAN, etc.) can be utilized in order to produce a saliency map just from the brain data. Examples of such other methods include, though are not limited to, transformer architectures and/or diffusion models (e.g., denoising diffusion models/score-based generative models, etc.) and other implementations that work in this context by adding Gaussian noise to the eye-tracking derived saliency map (the input data), repeatedly, and then performing learning to get the original data back by reversing the process of adding the Gaussian noise.

FIG. 9 depicts an exemplary user interface generated by a VR headset, consistent with various exemplary aspects of one or more implementations of the disclosed technology. Referring to FIG. 9, an exemplary user interface is depicted, e.g., as generated by the system/component(s) herein such as a VR or other headset, consistent with various exemplary aspects of one or more implementations of the disclosed technology. As shown in FIG. 9, an example user interface 1601, which may be two-dimensional (2D) or three-dimensional (3D) may be generated and employed to represent a ‘heat spot’ image indicating the locus of attention of the user and therefore which element the user would like to select in the environment.

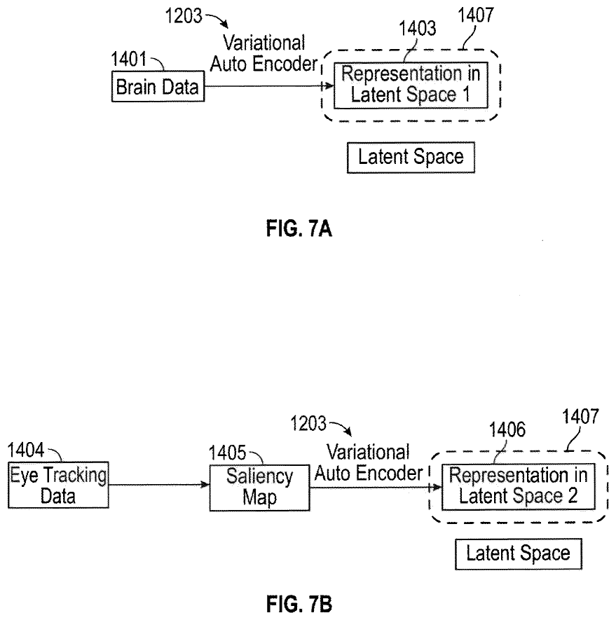

FIG. 10 depicts an illustrative flow diagram detailing one exemplary process of using a VR (and/or other) headset in combination with a BCI to create and compare a ground truth visual saliency map (e.g., developed from eye tracking) with a BCI-EEG generated visual saliency map, i.e., to update the performance of the generator adversarial network, consistent with various exemplary aspects of one or more implementations of the disclosed technology. Referring to FIG. 10, such overall, exemplary approach may be utilized to estimate visual attention of a user directly from EEG data taken from a BCI, while simultaneously recording data from VR headset eye tracking hardware and software components to create a visual saliency map to update and refine the EEG measurement data. Here, then, one illustrative process utilized to estimate visual attention directly from brain data, may include steps such as: creating images representing the features from brain data according to their spatial location on the participant scalp, at 1702; encoding of the brain data derived images using, at 1704, which may be performed, e.g., via a variational autoencoder (example above) or similar equipment or components; performing distribution mapping of the brain data latent space to the original/ground truth/eye tracking derived saliency map latent space, at 1706; decoding the distribution map to estimate the saliency map derived from the brain data signals alone, at 1708; and performing discrimination processing between the saliency map generated from brain data signals and the ground truth saliency map (e.g., developed from eye-tracking), at 1710. Consistent with such process, then, a loss function may be derived, which is then used to update the performance of the generator network. Accordingly, such processing provides for more accurately estimating visual attention directly from the brain data, such as by more accurately mapping the user's locus of attention using EEG signals detected through the BCI alone. Further, in other embodiments, such processing and modeling may also be utilized for other estimations from brain data. Here, by way of one example, a quantified map of a user's body movement may be derived from brain data, such as by first using a 3D body movement tracker or sensor, taking the place of the eye-tracker used in this visual attention context, and then generating an appropriate saliency map from the brain data associated with the brain activity derived from, for example, the user's premotor and motor cortices. Further, such ‘motor saliency map’ may then be utilized, to, e.g., predict the imagined and intended movement of a user purely from the brain data recorded from the premotor cortex, in the absence of tracking the user's body movements directly with an external body tracker. In another such example, a quantified emotional state of a user may be derived, such as by first using a combination of signals derived from external signals such as eye movements, heart rate, body movement, sweat sensors, glucose sensors, etc., to derive a quantified map of a user's emotional state by weighting the various external signals according to a graph or scale of human emotions and the corresponding bodily signals. Based on this, an appropriate saliency map from brain data from a across the user's neocortex may then be generated via a similar method to that described in the visual attention context, by having the machine learning network learn to generate the equivalent saliency map from the brain data alone. This ‘emotional saliency map’ may then be utilized to predict a user's emotional state automatically using, e.g., the presently described brain-computer interface headwear or equivalent.

Visual Attention Tracking with Eye Tracking and Utilization of BCI+Artificial Reality Saliency Mapping to Generate a Brain-Derived Selection (e.g., Click, Etc.)
1. Participant Wears a BCI Headgear with Eye Tracking and/or Artificial Reality Headset

With regard to initial aspects of capturing and/or gathering various BCI and/or eye-tracking information from a user, here, the technology illustrated and described above in connection with FIG. 5A through FIG. 8 may be utilized in some embodiments, though various inventions herein are not limited thereto. Namely, it is noted that, in the context of the inventions disclosed here, various other types of technologies, such as differing BCI and/or eye-tracking devices and their associated signals, may also be utilized in implementations consistent with the presently-disclosed technology, such as the alternative examples of devices (e.g., BCI and/or eye-tracking devices, etc.) set forth herein.

a. Electrode/Optode Arrangement with the Artificial Reality Headset

With regard to the electrode/optode arrangements, embodiments herein that involve capturing and/or gathering various BCI information from a user along with capture of eye-tracking information via use of an XR, VR, etc. headset may utilize the electrode/optode arrangement and related aspects set forth and described above in connection with FIG. 6A. Similarly, though, as above, it is noted that, in the context of these innovations, various other types of devices and technologies, such as differing BCI and/or eye-tracking devices and their associated signals, may also be utilized in such implementations, including the alternative examples of devices (e.g., BCI and/or eye-tracking devices, etc.) set forth herein.

a. Electrode/Optode Arrangement with No Artificial Reality Headset

With regard to the electrode/optode arrangements initial aspects of capturing and/or gathering various BCI information from a user without any corresponding use of such XR, VR, etc. headset, the electrode/optode arrangement and related aspects set forth and described above in connection with FIG. 6B may be utilized. In some embodiments, for example, such BCI electrode/optode configurations may be utilized for interactions with conventional 2D computer screens, phones, tablets, other screens, and the like. Further, as above, it is noted that, in the context of these innovations, various other types of devices and technologies, such as differing BCI devices and their associated signals, may also be utilized in such implementations, the alternative examples of devices (e.g., BCI, etc. devices) set forth herein.

### Systems and Methods Involving Brain State Assessment

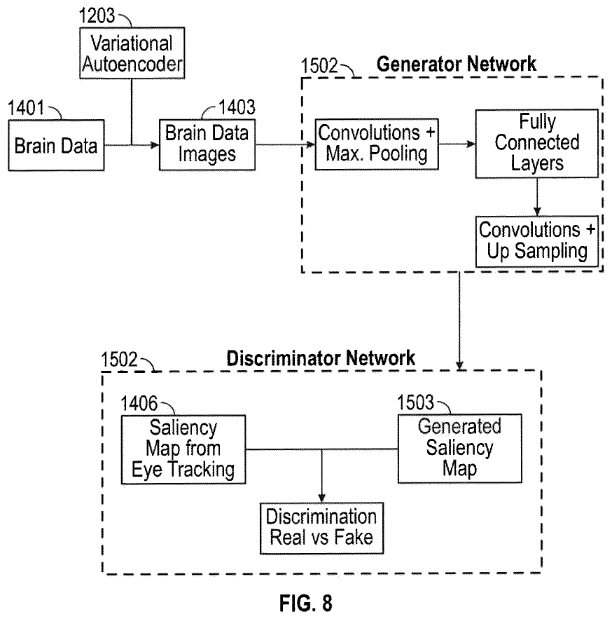

FIG. 11 depicts an exemplary flow diagram illustrating utilization of brain state assessment features during an artificial reality experience in connection with updating the experience, consistent with various exemplary aspects of one or more implementations of the disclosed technology. Referring to FIG. 11, the flow diagram 1800 illustrates aspects of implementations herein that utilize a developed gamified ‘pre-task’ to assess user brain state, such as where such tasks and pre-task are presented to the user in an artificial reality environment. As explained below in connection with various aspects of the brain state assessment innovations herein, such pre-tasks may be designed so as to evoke particular brain activity which are assessed to determine a user's brain state. In some embodiments, the pre-task or task may be selected as a function of the type of brain state the user is interested in measuring.

Turning to FIG. 11, the exemplary flow diagram 1800 begins with a user having brain measurements taken in connection with wearing an artificial reality headset, at 1802. Next, the user may, optionally, be exposed to a gamified task or experience, at 1804, which may include visual stimulus and where, e.g., user feedback responsive to such stimulus is recorded via the artificial reality headset. Further, brain data of the user is also captured, at 1806. Further, in the process flow of FIG. 11, the brain data being recorded may be parsed (in various ways, such as based on the data measured, other results, the location and/or type of data, etc.) into categories that are representative of the user's workload 1810 and the user's emotional state 1808 and/or, potentially, e.g. in certain other embodiments, other brain state indicators or indications (not shown). In a straightforward example of such functionality, for example, the pre-task or task may comprise a game based on manipulation of numbers, which may result in an assessment of workload 1810 by the user, and which can also be linked to various user-related measures such as stress and relaxation measurements, among others. Here, for example, the manipulation of numbers, e.g., counting, adding and/or subtracting etc., may be utilized in aspects herein for assessing workload, such as by using functional near-infrared spectroscopy (fNIRS) devices. Other brain monitoring techniques may be used, as well. Further, in some embodiments, such numbers manipulations or mental calculation aspects can easily be ‘obscured’ behind a myriad of gamified experiences, e.g. manipulating a virtual Rubik's® cube and counting the colored sides, counting colored balls, etc. Moreover, instead of mental calculation, various embodiments herein may involve the user playing other XR games with the brain state measurement(s) being assessed in connection therewith, or otherwise requiring the user to take actions and/or perform activities that elicit the brain state data desired.

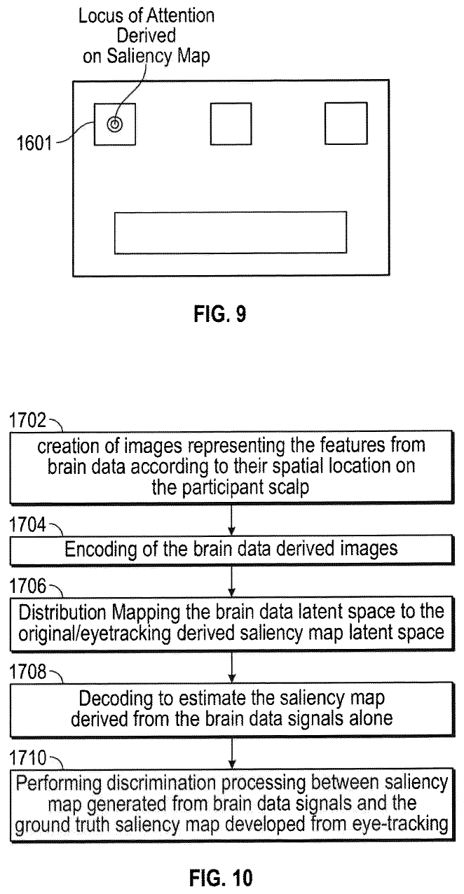

Turning back to FIG. 11, such brain assessment information and/or indicators, e.g., workload 1810, emotional state 1808, etc., may then be processed in connection with similar or related data previously obtained, at 1814, to perform a comparison that enables determination of metrics related to quality of the user's brain state, e.g., good, bad, etc., whether they appear to be overworked, whether their emotional state appears to need improvement, and the like. Furthermore, based on such processing, comparison and/or assessment, one or more suggestion or feedback may then be automatically provided or made, such as, in one example, to provide a particular type of artificial reality experience to move the user's mental state in the direction towards a more desired state along the range of a brain state measurement or spectrum of theirs, such as to become more relaxed. Such user feedback is denoted at 1816, and may, in some embodiments, take the form of data visualization(s) to show the brain state in a user-friendly way (examples shown and described, e.g., in connection with FIGS. 12A-12B) and then a suggested XR experience such as a meditation experience, i.e., that is known or believed to achieve the improvement in brain state desired.

In addition to providing such processing and feedback, systems and methods herein also, accordingly, provide a link between the artificial reality system and the BCI system, enabling associated knowledge and information of both to be fed back and utilized by one or both parts of such hybrid systems. Further, the user's previous brain state measurements may be stored in a databank, again shown at 1814. Here, in some embodiments, the user's brain state measurements, quantified over time each time they use their XR and BCI system, may be utilized to provide them an updated impression of how they are feeling relative to previous time points or periods recorded and stored for use by the system. In addition to maintain and augmenting such databank of valuable and helpful data and brain state information, additional aspects such as the user's progress regarding improvements to their brain state or other metrics can be built into the XR experience, where such features have an additional benefit of enhancing user retention, among other things.

FIGS. 12A-12B depict examples of illustrative data visualizations, such as those that may automatically displayed/shown to represent the user's brain state in a user-friendly way, e.g., via the XR environment, consistent with various exemplary aspects of one or more implementations of the disclosed technology. As noted above in connection with FIG. 11, various feedback and/or suggestions may be provided to the user, at 1816, based on the comparison, processing and/or assessment(s) made at 1812. FIG. 12A depicts one example representation or visualization that may be generated and displayed to the user, e.g. via a UI, according to one embodiment. Consistent with FIG. 12A, a straightforward dial, graph or indicator may be utilized to show the user one or more details of his or her current mental state, such as by showing the state or status on a scale, range or dial, or by displaying the results as a step or position related to a series or span of measured brain state. In the example of FIG. 12A, the indicator is provided as a simple dial 1900 that points to the measured state on the dial, where the dial is scaled from low (or zero, n/a) to high (very happy).

FIG. 12B depicts another illustrative representation or visualization 1950 that may be utilized to provide feedback and/or suggestions to a user, i.e., related to a brain state assessment of the user detected. In FIG. 12B, a visualization graph may be provided which illustrates the user's state in one or more ranges of brain state that are being detected, e.g., such as those shown and described in connection with FIG. 11. Referring to the example FIG. 12B, such visualization may show the detected workload of the user, e.g., from low to high, along one axis or other comparable scale/range, shown here along the Y-axis. According to such workload measure, as the user's workload is detected to be in higher ranges, the visualization may display such reading in upper regions of such graph, denoting also as a range of higher anxiety of the user. Further, such visualization may also (or instead) show a detected effort related to the user's brain state, which may also be shown along a scale from low to high, along another axis or other comparable scale/range, though shown here in FIG. 12B along the X-axis. According to such brain state measure, for example, as the user's effort is detected to be in higher ranges, the visualization may display such reading as a scale of boredom, or other similar expression, here denoted as higher or lower boredom that reflect when the effort being exerted is lower or higher. Such visualizations may include or depict a measure, point or other such reflection of the user's current state of mind, e.g., along, among or across the scales of mental state being depicted, such as the dial position 1902 in FIG. 12A, a point 1952 or region in the X-Y axis of FIG. 12B, or the like. Further, such visualizations may include or depict preferred or desired regions, e.g. 1904 in FIG. 12A and 1954 in FIG. 12B, which help illustrate to the user a more optimal state of mind they may wish to have, which may be shown in conjunction with the user's current state of mind measure to help illustrate and thereby better conceptualize the current state in relation to a preferred state. In the innovative graphical visualization of mental state of FIG. 12B, this region of optimized neural performance may be displayed as a band that may, in some example cases, be generally linear and having an increasing slope. Such region or band of optimized performance may represent ideal or preferred neural efficiency, i.e., just the right amount of neural resource allocation for the brain state or quanta being measured. Further, this region or band may take the form of any of a variety of shapes and sizes, and implementations herein may define and display a region, here, of any shape corresponding to historical information measured and/or otherwise known for a particular user, as this may differ from established norms and simple stripe shown in FIG. 12B, such as it will in certain embodiments and/or for some individuals.

Providing such feedback and insight to the user, along with other recommendations and/or information, can more readily allow a user to understand where their current state is, and what they may need to experience, consider, or acts they should do to help move their mental state to a more preferred region. One type of additional recommendation or information provided to a user, mentioned above, is a suggested XR experience, such as a meditation experience, though additional forms of such recommendations and information may be utilized. Providing feedback to a user in virtual reality based on their emotional state derived from their brain data may take many forms. Below are a few nonlimiting examples:
1. Calming feedback: If the user is experiencing anxiety or stress, the virtual environment can be adjusted to provide a calming atmosphere. For example, the lighting can be dimmed, the sounds can be softened, and soothing images can be displayed. Additionally, the virtual reality program can provide feedback to the user about their breathing rate and suggest deep breathing exercises to help them relax.
2. Music or Sounds: The system could play music or sounds that are known to have a calming effect on the user's brain, such as ambient music or nature sounds.
3. Haptic Feedback: Haptic feedback can be used to provide tactile sensations to the user, such as vibrations, pressure, or temperature changes. Haptic feedback could be used to provide gentle stimulation to help calm the user.
4. Virtual Companion: The system could generate a virtual companion for the user to interact with, such as a friendly animal or a supportive friend. The companion could respond to the user's emotional state and provide words of encouragement or support when needed.
5. Motivational feedback: If the user is feeling low or lacking motivation, the virtual reality program can provide positive feedback to boost their mood. For example, if the user is playing a game, the program can give them encouraging messages when they achieve a goal or perform well.
6. Personalized feedback: Based on the user's brain data, the virtual reality program can provide feedback that is tailored to their individual needs. For example, if the user has a fear of heights, the program can adjust the virtual environment to gradually increase the height, providing exposure therapy that is customized to their specific fear.
7. Social feedback: If the user is interacting with other people in the virtual reality environment, the program can provide feedback on how they are being perceived by others. For example, the program can provide feedback on the user's tone of voice, body language, and facial expressions, giving them insights into how they are perceived by others.
8. Real-time feedback: The virtual reality program can provide feedback in real-time, adjusting the virtual environment based on the user's emotional state. For example, if the user becomes bored or disengaged, the program can increase the level of challenge to keep them engaged.
   Overall, by using brain data to provide feedback in virtual reality, systems and methods herein may be implemented to create a more personalized and immersive experience that can enhance the user's emotional well-being and engagement. Here, it is also noted that the above illustrations are just a few examples, and the possibilities for providing feedback in VR are virtually limitless. Ultimately, the most effective feedback will depend on a variety of factors, such as the user's individual needs and preferences, the specific task or activity being performed, the technological capabilities of the VR system, and/or other factors.

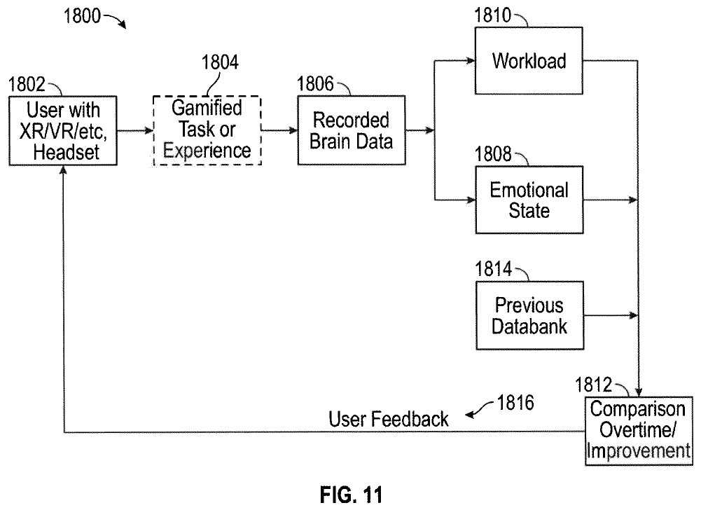

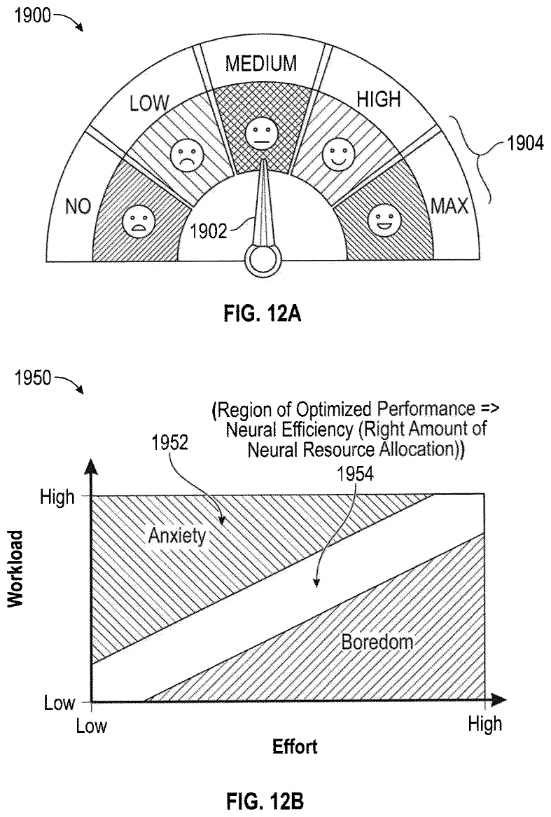

FIG. 13 depicts an exemplary flow diagram illustrating combined eye-tracking and brain data timestamping for use in brain state assessment in an XR experience, consistent with various exemplary aspects of one or more implementations of the disclosed technology. According to FIG. 13, the flow diagram 2000 illustrates an exemplary acquisition of a user brain state in an artificial reality context, and the resultant automatic updating of the XR experience, at 2016, e.g., in the absence of a particularly designed pre-task. Referring to FIG. 13, the flow diagram illustrates processing from both a brain interface system 2002 and an Extended/Mixed/etc. Reality System 2008, one with eye tracking virtual content running in parallel, namely as both systems are coupled to a user to measure brain state/brain activity and associated activity (e.g., eye movement, etc.). According to embodiments consistent with FIG. 13, the brain interface system 2002 may include or involve processing or signals from EEG, NRS, FOS, etc. systems. Further, such signal may then be temporally formatted and combined, at 2004. Following this, additional pre-processing may then be performed, at 2006, to bring the signals into suitable condition for processing with the datastream/signals being provided via the mixed reality system 2008. Here, for example, the brain signals from 2002 may be formatted, combined and pre-processed, in some embodiments, using advanced decoder methods (see, e.g., exemplary aspects outlined in connections with FIG. 14, below).

Further, in the context of such illustrative block and flow diagrams, it is important to clarify that the datastreams can go through separate signal processing pipelines and then be combined at the level of features, at the machine learning level, etc. At 2004, when it is says combined, the illustration of FIG. 13 simply indicates that the EEG trace and the NIRS or optical trace (one example set of BCI techniques that might be combined) are both being recorded simultaneously and therefore will have the same timestamping relative to events that are occurring in the virtual environment. Combining these two techniques can provide a more complete picture of brain activity than using either technique alone. One approach to combining EEG and NIRS is called hybrid EEG-NIRS or INIRS-EEG. In this approach, both EEG and NIRS signals are recorded simultaneously while the participant is in the virtual environment. The EEG and NIRS signals are then analyzed separately in real-time, by siphoning off the real-time data to the relevant signal processing pipeline, e.g., using standard techniques for each modality in one example. In the case of EEG signals, the raw EEG data is preprocessed to remove artifacts, filtered, and segmented into epochs that correspond to different phases of the task or stimulus. Similarly, the raw NIRS data is preprocessed to remove artifacts and then analyzed to determine changes in oxygenation and blood flow in different regions of the brain. In associated implementations, the location of the NIRS sensors may be utilized to guide the analysis of the EEG data by focusing on brain regions that show significant changes in oxygenation or blood flow. According to such aspects, for example, once the pre-processed data reaches the attention based sequence to vector model, it takes both the pre-processed EEG datastream and the NIRS datastream both as input, so it is combined on the level of the machine learning step by just taking both as input. Overall, consistent with this illustrated example, combining EEG and NIRS signals provides a more comprehensive view of brain activity.

In parallel with the temporal formatting of the brain data, at 2004, implementations herein may temporally format the outputs of the mixed reality system, at 2010, wherein outputs therefrom are provided with timestamps or other timing-related indicia. With such temporal formatting, implementations herein can align, compare and further process the brain interface system output data in conjunction with the mixed reality system output data, such as to establish which of the eye motion, actions and activities denoted in the mixed reality data stream correspond to their associate brain state measurements and signals being detected via the brain interface system.

Turning back to FIG. 13, the pre-processed brain state datastream from 2006 is then combined with comparably time-formatted mixed reality system datastream for submission to a further processing step, at 2012, e.g., to perform attention-based processing and/or vector determination(s). In step 2012, for example, the brain interface and mixed reality signals may be processed via an attention-based sequence of handling, e.g., to yield weighted and/or transformed data suitable for expression in various vector(s), matrices, etc. Here at 2012, for example, the signals have already been preprocessed in the aforementioned steps.

Once the preprocessed brain data is assembled in the form of a sequence of features, it may be feed into the sequence-to-vector model. According to embodiments herein, the model may process the sequence and produce a fixed-size representation that summarizes the emotional state of the user. This representation can then be fed into a classifier, such as a logistic regression or a neural network, to predict the emotional state. Other embodiments may utilize a sequence-to-vector model with attention mechanism. Here, for example, such model can learn to capture the temporal dependencies of the data by processing it as a sequence of time-steps, and then producing a fixed-size representation (vector) of the entire sequence. The attention mechanism can be used to weight the importance of different time-steps in the sequence when producing the final representation, thus allowing the model to focus on the most informative parts of the data.

In general, the basic idea behind a sequence-to-vector model is to take a sequence of inputs and produce a fixed-size output vector that summarizes the sequence. In the case of brain data, the sequence might correspond to a time series of EEG or fMRI measurements, and the output vector would represent the user's emotional state. A common approach to building a sequence-to-vector model with attention mechanism is to use a type of neural network called a recurrent neural network (RNN). An RNN is a type of neural network that can process sequential data by maintaining a “hidden state” that summarizes previous inputs. At each time-step t, the RNN takes an input vector x_t and updates its hidden state h_t according to the following equation:

$$h\_t = f ( Wx\_t + Uh\_ \{ t - 1 \} )$$

where W and U are weight matrices that the RNN learns during training, and f is a non-linear activation function such as the sigmoid or hyperbolic tangent function.
   The output of the RNN at each time-step t is then computed as:

$$y\_t = g ( Vh\_t )$$

where V is another weight matrix and g is another non-linear activation function. This output can be interpreted as a representation of the input sequence up to time t.
   To incorporate an attention mechanism into this model, a set of attention weights alpha_t are introduced that determine how much weight to place on each time-step when computing the final output. These attention weights are computed as follows:

$$alpha\_t = softmax ( w \hat{} T tanh ( Uh\_ \{ t - 1 \} + Vh\_t ) )$$

where w is a weight vector that is learned during training, and the softmax function ensures that the attention weights sum to 1.
   The final output vector, which summarizes the entire sequence, is then computed as a weighted sum of the RNN outputs, where the attention weights determine the weights of the sum:

$$y = sum\_t alpha\_t y\_t$$

The end result is that the emotional state may be classified according to the diagrams shown in the figures and the associated descriptions herein.
In short, the attentional aspect of the model, is used to ‘hone in’ on the aspects of the datastream which are most relevant in terms of the users emotion and this is done by computing the attention weights as described above. By adjusting the attention weights, more ‘focus’ is given to different aspects of the pre-processed datastream.

Turning back to FIG. 13, next, utilizing the transformed data and further processing of stage 2012, embodiments herein may identify and assess the user's emotional and/or mental state vectors (or otherwise codified/classified data) and determine any of a variety of different or updated virtual content to feedback and display or immerse the user in their relevant mixed reality environment. Such feedback (e.g., different or updated virtual content) may take the form of virtual experiences or content that brings the user into closer conformance with a desired or target mental state. Upon determination of this new virtual content, such updated virtual content may be fed back to the mixed reality system 2008 for presentation to the user, at 2016.

In accordance with embodiments consistent with FIG. 13, then, user brain state may be quantified, in any artificial reality experience, using advanced decoder methods (again, e.g., exemplary aspects outlined in connections with FIG. 14, below) and the XR experience may be updated according to the user brain state and a system of weighting the user's brain state vector(s) and/or matrix(ces). In some embodiments, such updating may be implemented in any number of contexts. For example, in one straightforward scenario, a game environment can be updated to result in increased challenge, enemy, etc. difficulty automatically when the brain state of a user is reflecting boredom. In other contexts, user brain state may be utilized to determine if a selection made by eye-tracking and a selection aspect of the brain interface system (see, e.g., U.S. provisional patent application Nos. 63/397,397, 63/397,398, and 63/397,399) is correct. Here, in one example, a user's disappointment may reflect that the selection system has made an error, and the XR experience can be updated to ‘unselect’ the erroneously selected option automatically.

FIG. 14 depicts an exemplary advanced decoder for a ‘no-pre-task’ mental state decoding process using automatic channel selection mechanisms, consistent with various exemplary aspects of one or more implementations of the disclosed technology. Embodiments herein may be provided according to the framework shown in FIG. 14, which depicts one illustrative advanced decoder comprising a spatial feature model 2110, a temporal feature model 2120, and a classifier 2130. Consistent with such implementations, embodiments herein utilize deep learning in an end-to-end manner, and do not require handcrafted features, e.g., as from EEG signals. In EEG signal processing, handcrafted features refer to features that are manually selected and extracted from the raw EEG signal, often by domain experts, in order to represent specific aspects of the signal that are believed to be relevant for a particular downstream analysis. These features may include measures of spectral power or coherence at specific frequencies, or time-domain properties such as amplitude or slope. The process of selecting and extracting these features requires a deep understanding of the underlying physiology and signal characteristics, as well as a large amount of domain expertise. On the other hand, end-to-end deep learning approaches aim to learn the most relevant features directly from the raw EEG signal, without relying on manual feature extraction. According to aspects of the disclosed technology consistent with these approaches, models herein may be composed of multiple layers of nonlinear transformations, each of which learns to encode progressively more abstract and higher-level features from the input signal. This allows the model to automatically adapt to the specific characteristics of the data in a data-driven way, without relying on preconceptions or expert knowledge about the signal. Again, disadvantages of using manual handcrafted features in EEG signal processing is that this approach can be labor-intensive, time-consuming, and often relies heavily on the subjectivity and expertise of the person doing the feature extraction. Such implementations can also be limited in their ability to capture complex and subtle patterns that may be present in the signal. In contrast, end-to-end deep learning approaches, as set forth herein, can learn to extract much more complex and informative features that are tailored to the specific task at hand, and can often achieve state-of-the-art performance on a wide range of EEG analysis tasks.

In accordance with the innovations of FIG. 14 and elsewhere herein, an effective deep learning framework is provided that can extract features and perform classification directly from raw EEG signals without the drawbacks any known systems would have. Referring to FIG. 14, various signal processing may first be performed via the spatial feature model 2110. Here, for example, in the spatial feature model 2110, implementations may utilize a convolutional neural network (CNN) to extract spatial information from EEG signals. According to some systems and methods, processing may then proceed to the temporal feature model 2120, which, in some embodiments, may employ two long short-term memory (LSTM) network layers to extract temporal information. Use of such LSTM layers is advantageous, in certain embodiments, as they may provide improved storing and accessing of information, such as versus standard recurrent neural network (RNN) processing and models. Further, while the disclosed model/processing may bear certain relation to a cascade convolutional recurrent network (CRNN), i.e., one which combines CNN and RNN to extract spatial and temporal features from EEG signals, various implementations herein add and utilize two or more attention mechanisms, such a channel-wise attention mechanism and an extended self-attention mechanism in innovative ways.

Moreover, while CNNs have been used before to extract brain data spatial features, e.g. from EEG, using just CNNs alone ignores important aspects regarding different features between different channels. Here, it is also noted that manual selection of channels that are more relevant may sometimes be performed in certain instances, in an attempt to pick more discriminative information.

Systems and methods herein, in further contrast, may also utilize automated methods, such as those utilizing an adaptive channel-wise mechanism. Here, for example, in some implementations, the channels may be converted to a probability distribution and then re-encoding of the initial brain data may be performed, such as based on the altered weights of the channels. In such embodiments, only after this adaptive channel mechanism is employed are the CNNs then used to extract the spatial features.

With such spatial features extracted, processing may proceed to the temporal feature model 2120, which may utilize a sequence-to-sequence model such as an LSTM to explore the temporal information of the brain data, in some embodiments. Accordingly, use of such combined automated channel selection mechanism, e.g. CNN for spatial features and a sequence-to-sequence model like an LSTM or a transformer for the temporal information, represents an innovative network and framework that may be utilized, here, to classify brain state automatically with no gamified task. Further, a transformer may be utilized in some implementations, especially with respect to LSTM embodiments herein, which process information sequentially, and hence do not accommodate advantages of running processing in parallel. Further, such transformers have an encoder-decoder architecture like RNNs, but they allow info to be passed in parallel. Accordingly, as opposed to RNN processing where one word is passed/processed at a time, with a transformer encoder, embodiments herein may be configured to pass all the words simultaneously and determine the word embeddings simultaneously. With regard to a timing window for processing signals and data, in some embodiments a 3 second window may be utilized. Other minor variations on the duration of such window may also be used. Here, for example, given that human mental states particularly in emotional states last between 1 and 12 seconds, a 3 s sliding window can be used to achieve a good accuracy in classification with the innovative networks and framework herein. Finally, the signals that have been processed temporally, at 2120, may then be sent to a classification stage 2130, which may include or involve a Softmax layer that transforms channel importance to a probability distribution or comparable mathematical expression, and hence which may thereby represent the importance of different channels. As to comparable expressions, there are several alternative functions that can be used in place of a softmax function, depending on the specific requirements of the task at hand. Below are a few examples:
Sigmoid function: The sigmoid function can be used for binary classification tasks, where there are only two possible categories. It produces a value between 0 and 1, which can be interpreted as the probability of the input belonging to the positive class.
ReLU function: The Rectified Linear Unit (ReLU) function is commonly used as an activation function in neural networks. It returns the input if it is positive, and 0 otherwise. ReLU can be used for image classification tasks, where the input is an image represented as a matrix of pixel values.
Softplus function: The softplus function produces continuous outputs that range from 0 to infinity, making it suitable for regression tasks. It is a smoothed version of the ReLU function, and has a smooth gradient that is useful for optimization algorithms.
Tanh function: The hyperbolic tangent (tanh) function is another commonly used activation function in neural networks. It produces outputs between −1 and 1, and can be used in any task where the output needs to be scaled to a specific range.

Accordingly, the total network, such as the exemplary advanced decoder network 2100 of FIG. 14, may therefore comprise (or contain only) a spatial feature module 2110, a temporal feature module 2120, and then a classifier 2130, according to certain embodiments herein. In one illustrative implementation, for example, such spatial feature model 2110 may include an automated channel selection mechanism that assigns weights to different channels based on their importance, a mean pooling layer for each channel of the brain data sample utilized to obtain channel-wise statistics, and have fully-connected layers to improve generalizability. In addition, the spatial feature model 2110 may also include or involve a Softmax layer may be utilized to transform channel importance to probability distribution which represents the importance of different channels. Further, a CNN may be utilized to extract spatial information.

In some embodiments, the network 2100 may include a temporal feature model 2120 containing means to perform recurrent structure processing, such as via a sequence-to-sequence model, a 2 layer or N-layer LSTM and/or transformer for processing the channel information, wherein the quantity of the LSTM units may be set based on the number of samples of brain data. And, as a final stage to the network 2100, a classifier stage may be employed, such as one utilizing a Softmax layer to perform classification by transforming the output from the previous layer into a vector of probabilities that sum up to one, with each component representing the probability of the input belonging to a specific class.

The input to the softmax function is a vector of scores, typically represented as a column vector of logits (i.e., unnormalized log probabilities, etc.) produced by the previous layer of the neural network. The function first exponentiates each score and then normalizes them by dividing each exponentiated score by the sum of all exponentiated scores. The formula for the softmax function is:

$$softmax ( x\_i ) = exp ( x\_i ) / sum ( exp ( x\_j ) )$$

where x_i is the ith score, and the sum runs over all possible values of j in the same vector.
   In other words, the softmax function maps a score vector to a probability vector. The output of a softmax layer is a vector of probabilities for each possible class that sums up to one. The class with the highest probability is then selected as the predicted class for the given input.
   During training, the softmax layer's parameters, such as weights and biases, are updated in order to minimize the difference between the predicted class probabilities and the true class labels. In some embodiments, this is accomplished utilizing an optimization algorithm that minimizes a loss function, such as cross-entropy or categorical cross-entropy, between the predicted probabilities and the true probabilities.

### Systems Having Integrated BCI+XR Hardware Units and Associated Processing Methods

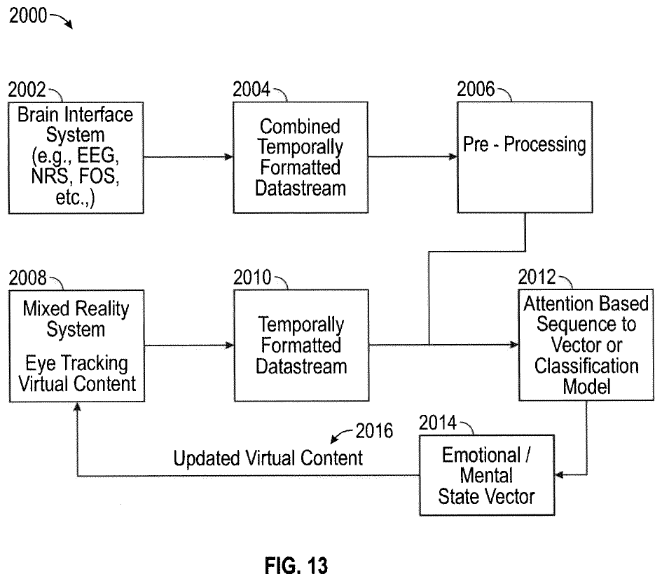

FIGS. 15A-15B depict exemplary implementations comprised of brain computer interface systems and mixed reality systems integrated together via a bidirectional interface, consistent with various exemplary aspects of one or more implementations of the disclosed technology. Referring to FIG. 15A, a user is shown wearing one illustrative integrated unit 1802 including an extended reality (XR) component 1804 and a brain interface component 1802. Other implementations and configurations beyond the one shown here in FIG. 15A are encompassed within the innovations herein. FIG. 15B depicts a block diagram of such integrated unit or device, including the integrated mechanical structure or device 1800, the brain interface system 1802, and the extended or mixed reality system 1804. A bi-directional communication interface 1806 between the two components is also illustrated in FIG. 15B. According to embodiments consistent with FIGS. 15A-15B, such brain interface 1802 and mixed/extended reality subsystems may both be housed in one integrated unit that is mechanically constructed to house or contain both subsystems.

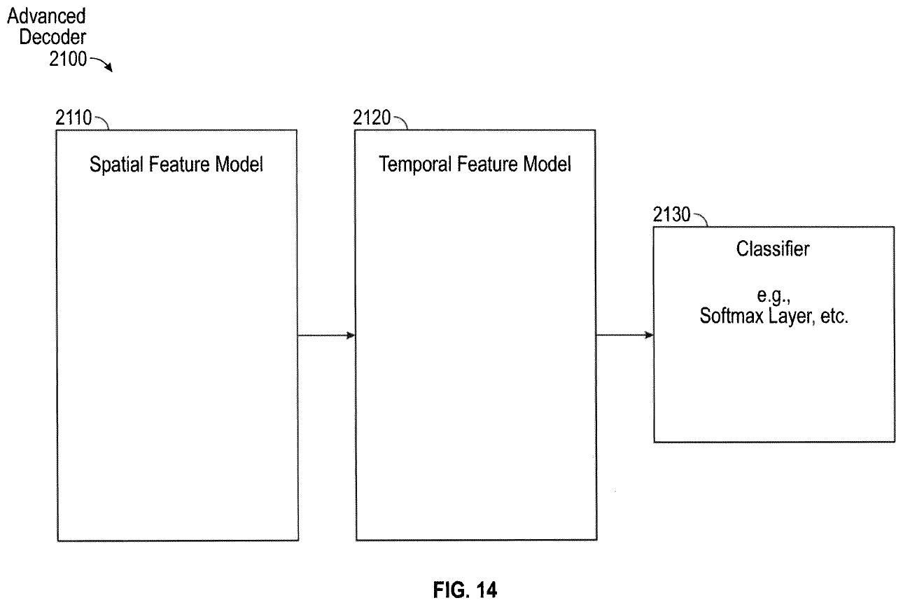

FIG. 16 depicts an exemplary feedback loop between an integrated brain computer interface system and a mixed reality system, consistent with various exemplary aspects of one or more implementations of the disclosed technology. Referring to FIG. 16, illustrative processing is shown starting at the user 1908, and begins with detecting brain activity, e.g., via a brain interface wearable, followed by recording this brain activity via a brain interface system, at 1902. Such brain activity is then transmitted to one or more processing components, at 1904, where analysis of the brain activity occurs. As a result of this processing, additions, adjustments or other changes are determined as desirable for the user's mixed reality experience, followed by generation and transmission of associated commands to effect these changes at and by the mixed reality system, at 1906. Once the commands from the processor are received, the mixed reality system 1906 generates and provides associated updated/changed views and experiences back to the user, at 1908. As such, consistent with such exemplary feedback loop between the BCI system and the XR system of FIG. 16, brain activity processed from the BCI system may be utilized to update the XR experience provided by the XR system.

According to various embodiments herein, the disclosed technology may involve aspects of brain data processing and/or classification that are implemented using advanced machine learning techniques in real-time VR environments, such as:

### Brain-Computer Interface (BCI) for Object Classification:

1. Utilizing a combination of a VR environment and a BCI system, a user may interact with virtual objects using their thoughts. Brain data from the user's brain could be recorded using a high-resolution headset, and advanced machine learning techniques such as deep neural networks could be used to classify the user's intent in real-time. Here, for example, the user could imagine moving a virtual object to the left, and the BCI system could translate this intent into actual movement of the object.

### Emotional State Classification:

2. Embodiments, here, may be implemented via classifying a user's emotional state in real-time while they interact with a VR environment. Here, for example, this may be performed via recording EEG data using a headset, and then processing the data using advanced machine learning techniques such as Recurrent Neural Networks (RNNs), Long Short-Term Memory (LSTM) models, etc. According to further aspects, the processed data may then be classified into different emotional states such as happy, sad, angry, neutral, etc., based on established patterns in EEG signals associated with these states.

### Cognitive Load Classification:

3. According to certain implementations, a user's cognitive load may be classified in real-time while they interact with a VR environment. Here, for example, brain data may be recorded using a headset, and then processed using advanced machine learning techniques such as Convolutional Neural Networks (CNNs), Support Vector Machines (SVMs), etc. Further, the processed data may then be classified into different cognitive load levels, e.g., based on established patterns in EEG signals associated with different cognitive loads.

### Spatial Navigation Assistance:

4. In some aspects of the disclosed technology, a user's brain data may be processed in real-time to provide spatial navigation assistance while they explore a VR environment. Here, for example, brain data may be recorded using a high-resolution headset, and machine learning techniques such as Neural Networks, etc. may be utilized to analyze the data and identify areas of the brain associated with spatial navigation. Further, the output of the analysis may then be utilized to provide the user with real-time navigation guidance, such as directional cues or maps, to help them navigate the virtual environment.

### Real-Time Brain-Computer Music Interface (BCMI):

5. Consistent with such BCMI embodiments, a user's brain data may be processed in real-time to generate music based on their cognitive state or emotional state while they interact with a VR environment. Here, for example, brain data may be recorded using a headset, and advanced machine learning techniques such as Generative Adversarial Networks (GANs), Variational Autoencoders (VAEs), etc. may be utilized to generate music based on the user's brain data. Further, the music may then be played back to the user in real-time, providing a unique, personalized music experience.
   Above are just a few examples of the types of brain data processing and classification that may be implemented in real-time VR environments using advanced machine learning techniques.

According to various aspects of the disclosed technology, the implementation architecture utilized for the machine learning model may be a combination of convolutional and recurrent layers, which allows implementations herein to capture both spatial and temporal dependencies in the brain data. In some embodiments, the convolutional layers may be utilized to extract spatial features from the brain signals, while the recurrent layers may capture temporal dependencies between the different epochs. Further, with regard to the disclosed technology, this type of architecture has been shown to be effective for EEG-based BCI applications, as it can capture the complex spatio-temporal patterns in the signals that correspond to different types of movements.

Overall, systems and methods involving such machine learning models are capable of accurately classifying the user's imagined object movements based on their brain signals in real-time. Further, these embodiments may leverage the latest advancements in deep learning and brain signal processing to achieve high performance and reliability, which is critical for a BCI application in a VR environment where accuracy and responsiveness are key factors in user experience.

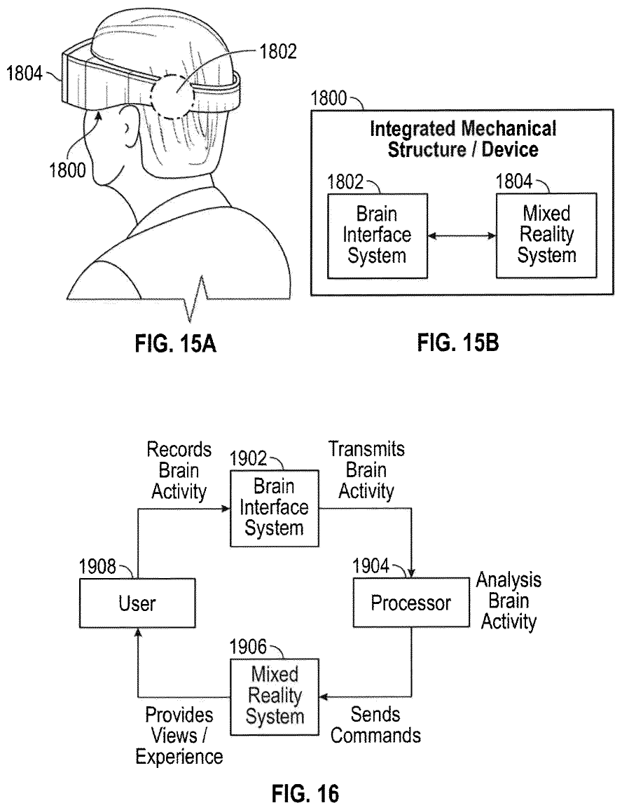

FIG. 17 depicts an exemplary flow diagram illustrating aspects associated with combining temporally-formatted data streams from the integrated brain computer interface and the mixed reality system as well as associated analysis of event-related brain data, consistent with various exemplary aspects of one or more implementations of the disclosed technology. Referring to FIG. 17, illustrative processing of integrated systems herein is shown commencing at the user 2002, and begins by acquiring both brain activity data by the brain interface system, at 2004, and acquiring mixed reality data via the mixed reality system, at 2014. The brain interface system then time stamps (or adds other timing indicia to) the measured brain activity data and transmits this time-stamped data stream, at 2006, to one or more processor components or stages 2008. In parallel, the mixed reality system time stamps (or adds other timing indicia to) the measured mixed reality data and transmits this time-stamped data stream, at 2012, to the one or more processor components or stages 2008. Next, the one or more processors 2008 combine and process both sets of time stamped data streams 2006 and 2012. As such, consistent with such processing, FIG. 16 illustrates how temporally formatted datastreams from the BCI or brain interface system 2004 and from the XR/mixed reality system 2014 may be combined by a processor to enable event-related brain data to be analyzed in conjunction with occurrences in an XR experience.

As set forth herein, combining temporally formatted data streams from a brain interface system and from a VR/mixed reality system can provide valuable insights into how the brain responds to events in a virtual environment. According to implementations herein, one example of how such integration may be accomplished is as follows. First, the brain interface system may record the user's brain activity in real-time using electroencephalography (EEG), functional magnetic resonance imaging (fMRI), and/or other neuroimaging techniques. This data would be recorded in a temporally formatted data stream, which would include time-stamped samples of brain activity. Second, the VR/mixed reality system would track the user's movements and interactions in the virtual environment. This data would also be recorded in a temporally formatted data stream, which would include time-stamped samples of the user's position, orientation, and actions in the virtual environment. To combine these two data streams, a processor could be used to synchronize the timestamps of the data streams, aligning the events in the virtual environment with the corresponding brain activity. Further, in some embodiments, the processor may utilize a common time reference, such as a system clock, to ensure that the data streams are synchronized. Once the data streams are synchronized, the processor can then enable event-related brain data to be analyzed in conjunction with occurrences in the VR experience. Here, for example, the processor could detect when the user performs a specific action in the virtual environment, such as picking up an object, and then analyze the corresponding brain activity to identify any patterns or changes in the brain activity associated with that action.

Consistent with the disclosed technology, such integration technology may be particularly useful in applications such as neurorehabilitation or cognitive training, where the virtual environment can be used to provide specific stimuli or challenges that can elicit certain brain responses. By analyzing the corresponding brain activity, systems and methods herein can provide feedback to the user and adjust the VR experience to optimize the training or rehabilitation program.

Further, according to certain implementations herein, synchronizing the timestamps of the data streams may be accomplished to two steps: determining the time offset between the two streams and then applying that offset to align the streams. In some embodiments, to determine the time offset, the processor may identify a common reference point in both data streams. In one example way of doing this, a marker that is simultaneously present in both streams may be utilized. Here, for example, a visual cue may be utilized, such as a flash of light at a particular frequency or an audio cue (e.g., similar in concept to the clapperboards used in movie production to align visuals with audio in post-production, etc.), that is presented in both the VR environment and in the brain data stream. In some embodiments, the time at which this marker occurs can be identified in both data streams, providing a common reference point for synchronization. Once the reference point has been identified, the processor can then calculate the time offset between the two data streams. Here, for example, this can be done by comparing the timestamp of the marker in the VR data stream to the timestamp of the marker in the brain data stream. Further, if the time difference between the two markers is known, then the time offset between the two data streams can be calculated as the difference between the two timestamps.

With the time offset calculated, the processor can then apply this offset to align the two data streams. Here, for example, if the VR data stream has a timestamp of 1000 ms for a specific event, but the corresponding event in the brain data stream has a timestamp of 1020 ms, then the processor can adjust the brain data stream by subtracting 20 ms from all timestamps to align it with the VR data stream. Technically, consistent with one or more implementations herein, this synchronization process can be programmed using a combination of software and hardware components. In some embodiments, the software component may involve utilizing a synchronization algorithm that identifies the common reference point, calculates the time offset, and applies the offset to align the data streams. Such algorithm may be programmed using a variety of languages and frameworks, such as Python, MATLAB, or C++. In some embodiments, the hardware component involve integrating the brain interface system and the VR/mixed reality system with the processor, so that the data streams can be received and processed in real-time. In some instances, this involves using specialized hardware interfaces, such as analog-to-digital converters or USB adapters, to connect the devices to the processor. Overall, the synchronization process involves identifying a common reference point, calculating the time offset, and then applying this offset to align the data streams. Such features may be implemented using a combination of software and hardware components, and may be utilized to enable event-related brain data to be analyzed in conjunction with occurrences in a VR experience.

One straightforward example implementation of a synchronization algorithm, using a visual marker which elicits a particular response in the brain data, is as follows:

```
import numpy as np
# Sample data for the VR data stream
vr_data = np.array([[0, 1, 2, 3, 4], [1, 2, 3, 4, 5], [1, 2, 3, 4, 5]])
# Sample data for the EEG data stream
eeg_data = np.array([[0, 1, 2, 3, 4], [2, 3, 4, 5, 6], [3, 4, 5, 6, 7]])
def synchronize_data(vr_data, eeg_data):
  # Identify a common reference point in both data streams
  # Here, assume that the marker occurs at index 2 in both data streams
  marker_index = 2
  # Calculate the time offset between the two data streams
  # Here, assume that the VR data stream is delayed by 50 ms relative to the EEG data stream
  vr_offset = −50
  # Apply the time offset to align the two data streams
  synchronized_eeg_data = eeg_data + vr_offset
  # Return the synchronized data streams
  return vr_data, synchronized_eeg_data
# Synchronize the data streams
synchronized_vr_data, synchronized_eeg_data = synchronize_data(vr_data, eeg_data)
# Print the synchronized data streams
print(“Synchronized VR data:”, synchronized_vr_data)
print(“Synchronized EEG data:”, synchronized_eeg_data)
```

In this example, the synchronization algorithm is programmed accounting for a visual marker to be present in both the VR data stream and the EEG data stream, and that this marker occurs at index 2 in both data streams. The algorithm then calculates that the VR data stream is delayed by 50 ms relative to the EEG data stream, and applies this offset to align the two data streams. Note that this is a simple example implementation for illustrative purposes, and in practice, the synchronization algorithm can be more sophisticated to account for variations in the time delay between the two data streams and also to allow for other forms of marker that act as a reference point for aligning the data streams.

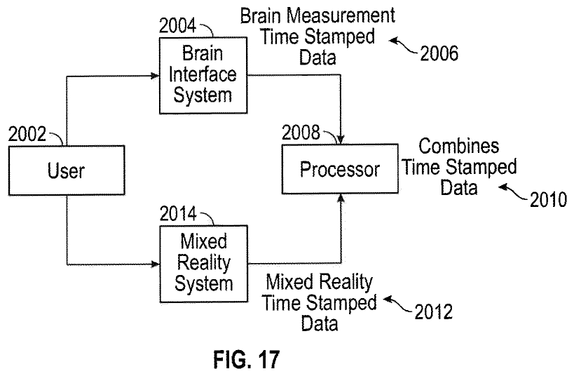

FIG. 18 depicts an exemplary flow diagram illustrating aspects associated with combining the temporally-formatted data streams as well as decoding the user's attention and intention in the XR experience, consistent with various exemplary aspects of one or more implementations of the disclosed technology. Referring to FIG. 18, illustrative processing of integrated systems herein is shown commencing at the user 2102, and begins by acquiring both brain activity data by the brain interface system, at 2104, and acquiring mixed reality data via the mixed reality system, at 2108. The brain interface system then time stamps (or adds other timing indicia to) the measured brain activity data and transmits this time-stamped data stream, at 2105, to one or more processor components or stages 2106. In parallel, mixed reality data is acquired and includes data regarding eye tracking of the user from an eye tracking component 2110. Processing of this mixed reality and eye tracking data then proceeds with temporally formatting of this data stream, at 2112. Here, for example, time stamps (or other timing indicia) are added to the mixed reality and eye tracking data, and the resulting data stream is transmitted to one or more processor components or stages 2114. According to embodiments herein, both the data streams are temporally formatted relative to the events occurring in the XR experience.

Next, both sets of time stamped data streams (from 2106 and 2114) are combined and further processed to determine locus of attention of the user within the experience. Here, the context needed to determine such locus or loci of attention may be derived as a function of the the event data streams being timestamped in the both the extended/mixed reality (and eye tracking) context and in the brain interface system measurements context. Accordingly, for example, timing information as to when the user has encountered a particular object is identifiable in the timestamped/temporally formatted datastream. Locus of attention may then be calculated as a function of such timing information and gaze location information, e.g., such as determined via the eye tracking components. Finally, with such locus of attention determined, the processors may then decode intention of the user, at 2120, and provide a variety of outputs needed based on such intent determination. As such, according to such processing consistent with FIG. 18, the temporally formatted data streams may be utilized, for example, to decode the user's attention and to determine intention in an XR experience based on the context of the experience.

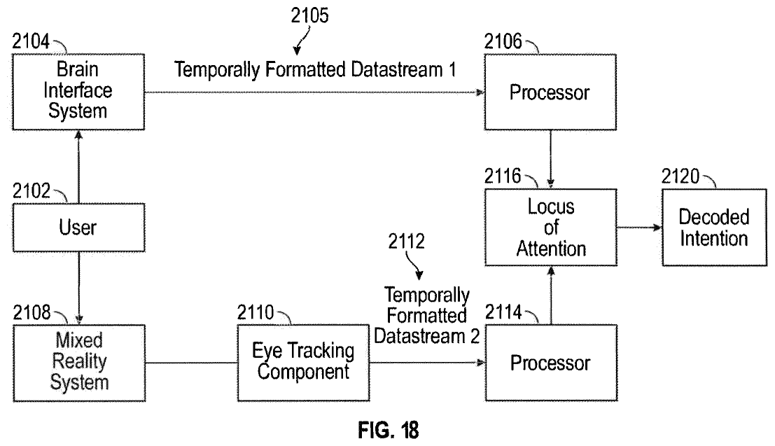

FIG. 19 depicts an exemplary flow diagram illustrating aspects relating to how the temporally-formatted brain data may be split and processed as particular types of brain data, consistent with various exemplary aspects of one or more implementations of the disclosed technology. In the illustrative implementation shown in FIG. 19, for example, the particular types of brain data processed are brain data corresponding to an intention to select a UI element in the XR experience, and brain data used to determine an alternative brain measurement. Referring to FIG. 19, illustrative processing is shown commencing at the user 2202, and begins with detecting brain activity and processing BCI brain signals via the brain interface system 2204, including temporally formatting the BCI data stream before transmitting it to one or more processing components 2212, as explained above. In parallel, as also explained above, user experience data is gathered and processing via the extended/mixed reality system 2208, including temporally formatting the XR/mixed reality data stream, at 2210, prior to transmitting it to the one or more processors 2212.

Next, with regard to subsequent processing, the one or more processors are configured to functionally split the temporally formatted brain data into brain data corresponding to an intention to select a UI element in the XR experience, at 2214, and brain data used to determine an alternative brain measurement, at 2216. Further, these two groupings are simultaneously generated and both of these simultaneous groupings of temporally formatted brain data may then be utilized to change the XR experience being provided in real-time. Here, for example, at 2214, the one or more processors first determine brain pattern(s) associated with the user's intention to make a selection (e.g., a UI selection) in the XR experience, and then generate one or more associated commands to update the virtual environment, at 2220. Simultaneously, at 2216, the one or more processors first detect and process brain data associated with an alternative brain measurement of the user, and then generate one or more associated commands, at 2218, to display selection of the UI element representing the alternative brain measurement for transmission to and selection thereof in the virtual environment, at 2220. As such, according to such processing consistent with FIG. 19, the temporally formatted data streams may be combined though also then simultaneously grouped to, for example, both update and display new selection(s) of UI elements in the XR/mixed reality experience in real time.

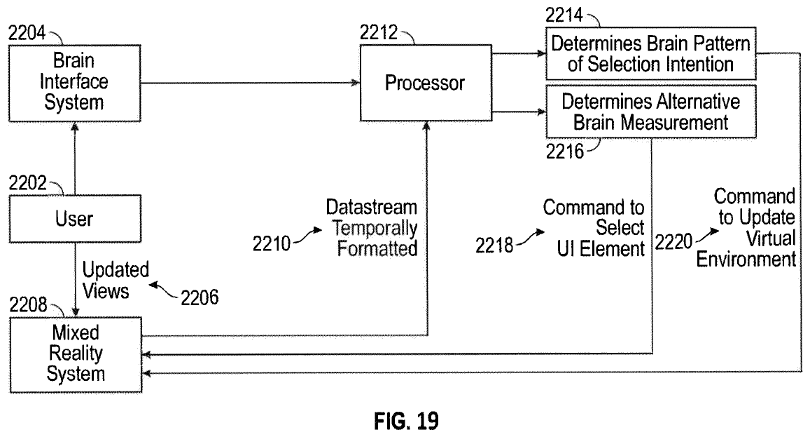

FIG. 20 depicts an exemplary system and setup wherein the brain computer interface technology is integrated/integral with the structure of an extended reality (XR) wearable 2300, consistent with various exemplary aspects of one or more implementations of the disclosed technology. Referring to FIG. 20, a wearable device 2300 is shown including, in this example embodiment, an XR/mixed reality eye goggle portion 2301 and one or more optical modules 2306, 2310 that contain the optical and/or electrical detectors of brain computer interface (BCI) system. As shown in FIG. 20, the optical modules 2306, 2310 may include one or more tiles 2302, 2304 that each comprise electrical signal (e.g., EEG, etc.) detecting sensors and or optical signal emitters/detectors (e.g., optodes, etc.). In the example AR glasses of FIG. 20, such brain computer interface (BCI) technology is shown, at 2310, as being integrated into the structure of the XR wearable, namely into the arms of the AR glasses.

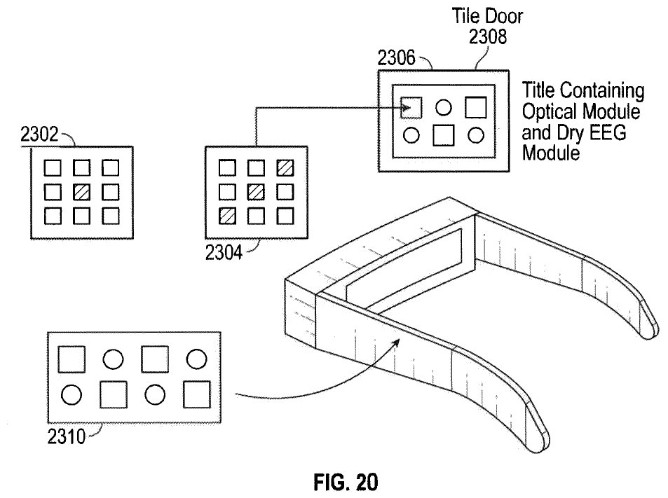

FIG. 21 depicts another exemplary system and setup 2400 wherein the integrated wearable device for a user 2402 includes an extended area brain detection region 2404, such as one utilized for higher density recording, consistent with various exemplary aspects of one or more implementations of the disclosed technology. FIG. 21 illustrates an example extended area brain detection region 2404 that may be utilized for higher density recording as part of a BCI component 2412 integrated into an XR wearable, e.g., in this case a VR headset. Referring to FIG. 21, the extended BCI component area 2404 in this case is shown placed primarily over the visual cortical areas, and may be further designed to decode users attention and intentions using methodologies from U.S. provisional patent applications P2, P3, and P4.

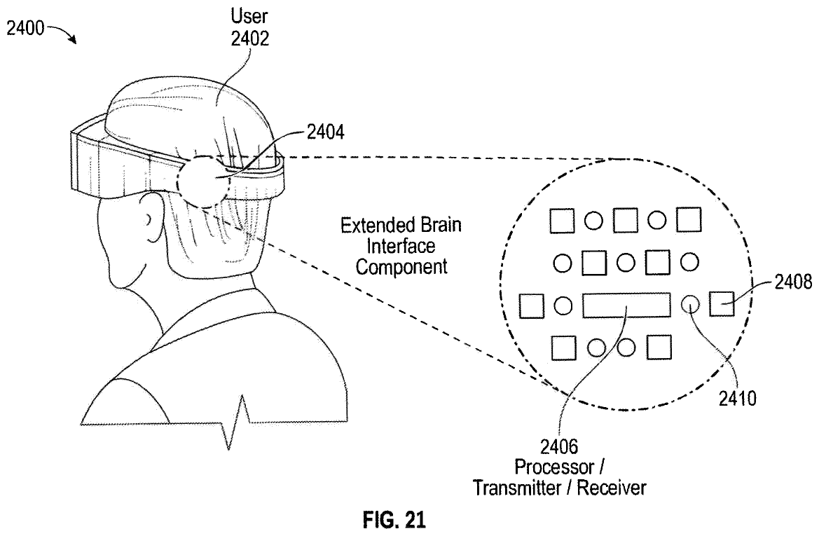

FIG. 22 depicts an exemplary system overview illustrating representative subcomponents of the integrated brain computer interface system 2510 and the extended reality system 2520, consistent with various exemplary aspects of one or more implementations of the disclosed technology. Referring to the illustrative embodiment of FIG. 22, a representative BCI system 2510 may include sensor technology 2512 and a processing unit 2516. Further, the sensor technology 2512 may include one or more tiles 2514, each of which may include various optical and/or electrical sensor sets, such as optode sets, dry EEG sensor modules, etc., as described elsewhere herein. Further, in FIG. 22, a representative XR/mixed reality system 2520 may include a head mounted display 2522, an eye tracking module 2524, at least one processor 2526, memory 2528, and a controller 2530. Further, as set forth previously, the BCI system 2510 and the XR system 2520 may be coupled together with a bidirectional interface.

### High-Density Diffuse Optical Tomography (HD-DOT) Brain Interface Implementations

According to some embodiments, systems and methods herein may include or involve aspects of high-density diffuse optical tomography (HD-DOT) brain interfaces. Here, for example, in some embodiments, devices consistent with such embodiments may comprise a HD-DOT brain-computer interface that is combined and/or integrated with an artificial reality headset, such as described above.

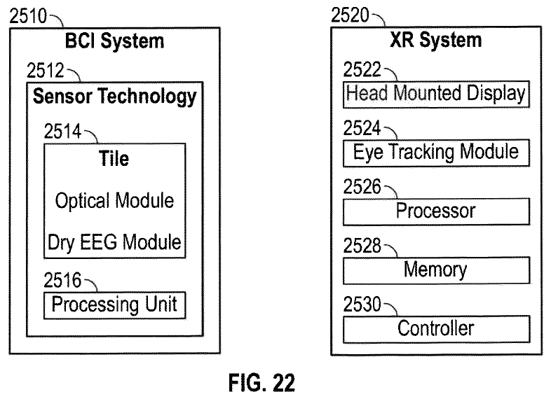

FIG. 23 depicts an exemplary flow diagram 2600 illustrating aspects relating to usage and associated processing regarding a high-density diffuse optical tomography brain-interface, consistent with various exemplary aspects of one or more implementations of the disclosed technology. Referring to FIG. 32, the illustrative data processing flow begins at 2602 where an optical HD-DOT brain interface apparatus may collect raw optical data. Then, at 2604, an automated signal processing pipeline may be applied or commence, e.g., in real-time. In parallel, digitized optode position information may be utilized, at 2610, in the creation of a 3-dimensional mesh model for the user, at 2612. Here, for example, certain implementations may utilize vector and/or matrix models to represent the positions of the optodes, and may combine such representations with a generalizable head model to thereby automatically generate the 3D mesh model 2612 for the user.

Next, at 2606, the combination of the result of the signal processing chain 2604 and the 3D mesh model 2612 may be combined to produce a 3D reconstruction of absorption changes with the light data, at 2606. In some embodiments, such 3D representation may either be displayed or, optionally, decompressed into a 2D tensor format, e.g., at 2620, which is a highly applicable format for use in modern computer vision analyses herein. Further, such outputs may then be provided and/or utilized in various computer vision analyses, at 2624, such as convolutional neural network analyses, other machine learning analyses, and the like.

Turning to certain illustrative embodiments, various HD-DOT arrays, channel configurations, source-detector arrangements, and other configurations may be utilized consistent with the innovations herein. According to such embodiments, for example, HD-DOT arrays herein may be configured to provides channels with several different source-detector separations, such as channels spanning the ‘short separation’ (SS), e.g., less than 15 mm in some embodiments, to ‘long’ separation, e.g., greater than or equal to 30 mm in some embodiments. Moreover, in some embodiments, illustrative HD-DOT arrays may be configured to provide overlapping spatial sensitivity profiles at each of these separations throughout the field of view. It is noted that implementations using HD-DOT arrays and associated signals and processing may provide depth-resolved images of superior quality to fNIRS or other diffuse optical imaging approaches. Furthermore, such mutual information obtained from the plurality of overlapping channel measurements increases spatial resolution. Additionally, embodiments utilizing such multiple source-detector separations improves both lateral and depth specificity.

Referring next to some technical aspects underlying and/or utilized in connection with the innovations herein, various diffuse optical tomography (DOT) and high-density diffuse optical tomography (HD-DOT) methodologies may be involved. Diffuse optical tomography (DOT) techniques may be used to reconstruct sparse multichannel NIRS data into spatial maps. In some embodiments, partially overlapping measurements may be reconstructed to produce 3D maps of brain function. Further, here, high-density diffuse optical tomography (HD-DOT) systems may be implemented using dense regular arrays of sources and detectors to obtain overlapping measurements at multiple distances. In some embodiments, for example, a closest short separation or short distance (SD) may be set at, e.g., 15 mm max.

It is also noted that diffuse optical tomography (DOT) methods reconstruct spatially overlapping multidistance source-detector measurement channels into three-dimensional (3D) maps with some level of depth profiling. In some embodiments, high-density diffuse optical tomography (HD-DOT) methods herein may use a nearest source-detector spacing of at most 15 mm to reconstruct 3D maps that have been shown to approach a spatial resolution comparable to that of fMRI.

Additional overview of how such high-density diffuse optical tomography (HD-DOT) methodologies may be implemented consistent with the innovations herein follows. According to some embodiments, initial data collection may involve (i) locating source and detector positions on the head, and (ii) recording light levels from the head of a participant. In one such illustrative scenario, here, for example, a stimulus paradigm might involve the participant generating novel verbs in response to nouns presented on a monitor. Further, a head model for a given participant may be created by generating a subject-specific or atlas-based volumetric segmentation of the head tissue, building a high-density mesh, placing the sources and detectors on the head mesh surface. Using such a head model, the sensitivity profile for each source, and each detector may be calculated and combined into a sensitivity profile for each source-detector measurement pair ASD. In some aspects, full system sensitivity may be visualized, modeled and/or processed by summing the sensitivity of each measurement pair. Further, the modelled sensitivity may then be spatially registered to an atlas space, e.g., for group-level and/or other analyses. Separately, in some embodiments, the collected light-level data may be assessed for noise and signal level quality, with high quality optical data clearly showing a pulse waveform.

After such preprocessing, such optical data may be combined with a regularized inverse of the sensitivity model to generate anatomically-registered maps of cerebral hemodynamics reflecting brain function. Further, in some embodiments, image reconstruction may be implemented utilizing known techniques of forward light modelling and the inverse problem with the sensitivity/jacobian matrix.

HD-DOT systems and methods herein utilize near-infrared light to produce high-resolution 3D images of biological tissues. This is achieved by projecting light into the tissue and measuring the scattered light at various locations on the surface. The scattering of light through the tissue can be modeled using the diffusion equation, which describes how photons diffuse through the tissue. To solve the inverse problem of reconstructing the 3D properties of the tissue from the scattered light measurements, a forward model of the light propagation through the tissue is required. The forward model takes into account the scattering and absorption properties of the tissue at different depths and angles. The solution to the forward model can be represented as a matrix, which is used to generate the forward scatter maps (FSMs) that represent the expected scattering of the transmitted light in each direction.

The Jacobian matrix is a mathematical tool used to describe the sensitivity of the measurements to small changes in the forward model. In other words, it provides a way to estimate how much the scattered light measurements change when the tissue properties change. This matrix is calculated using the forward model and is used in the inverse problem to estimate changes to the model that will improve the reconstruction.

The inverse problem is typically solved using an optimization method such as a non-linear least squares algorithm. The goal is to minimize the difference between the measured scattered light and the predicted scattered light from the forward model. The Jacobian matrix helps guide the optimization process by showing how much the measured scattered light would change if certain parameters in the forward model were changed.

Ultimately, the reconstruction algorithm uses the forward model and the inverse problem to estimate the optical properties of the tissue from the raw surface measurement data. By solving this problem and applying suitable visualization techniques, a 3D image of the tissue can be formed.

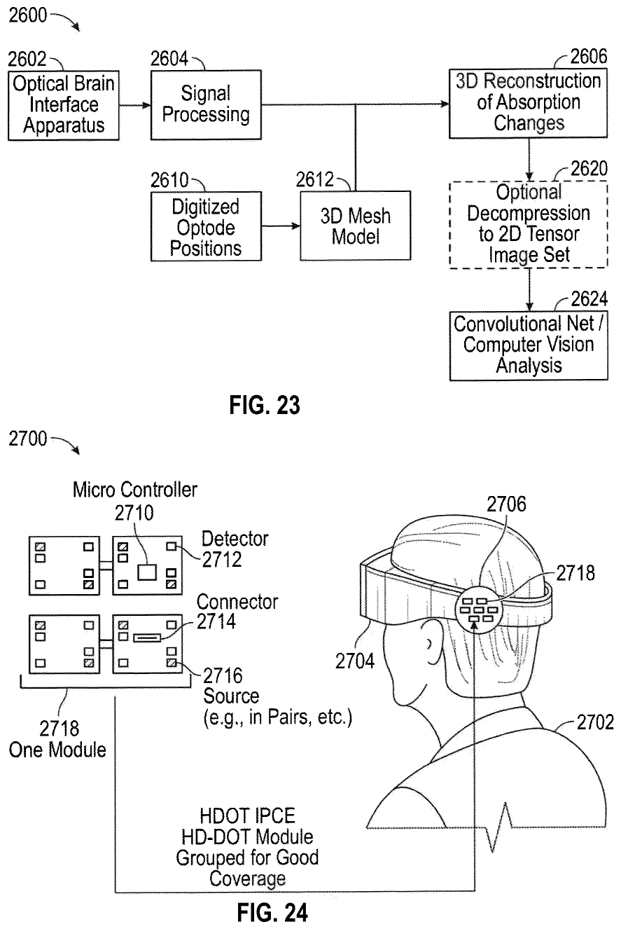

FIG. 24 depicts an exemplary system and wearable setup 2700 illustrating aspects of a representative optical tomography brain interface integrated into a wearable XR/mixed reality apparatus, consistent with various exemplary aspects of one or more implementations of the disclosed technology. In FIG. 33, for example, one illustrative wearable modular and fiberless on-head HD-DOT system design is shown. Referring to FIG. 33, a user 2702 is shown with one such wearable device 2704 on his head, the wearable device including one illustrative brain interface component 2706 shown. Further, each such brain interface component 2706 may comprise one or more diffuse optical tomography (DOT) modules 2718. In various embodiments, one or more of such brain interface components 2706 may be employed and they may be distributed at various positions around the user's head and brain, wherever appropriate to detect the brain signals needed for the brain signal processing desired. Referring to the example embodiment depicted in FIG. 33, one such illustrative DOT module 2718 may comprise, or consist of, four detectors 2712 (e.g., photodiode detectors, etc.), two optical sources 2716 (e.g., LEDs, light sources, etc.), and, optionally, a micro controller 2710 and/or connector 2714 (e.g., connector pins, etc.). Such modules may be constructed, configured and/or grouped to provide or maximize desired IPCE (incident-photon-to-current efficiency). In some embodiments, each detector may be attached to the analog input of an analog-to-digital converter (ADC). Additionally, according to certain exemplary systems, implementations herein may have normalized array sensitivity, e.g. at 770 nm, displayed on a cortical mesh of a single subject. Further, certain of the present systems and methods may utilize instrumentation that is applied as a frequency domain instrument rather than a continuous wave instrument. Here, such implementations may be especially beneficial because the additional phase delay measurements can provide better information relating to neural activity.

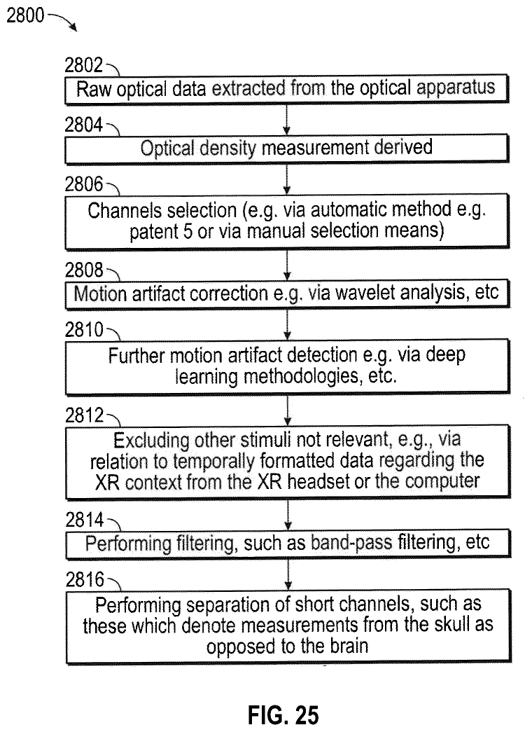

FIG. 25 depicts a flowchart illustrating an exemplary signal processing chain for optical data associated with a representative optical tomography brain interface, consistent with various exemplary aspects of one or more implementations of the disclosed technology. Referring to FIG. 34, an illustrative method 2800 is shown, including extracting raw optical data from the optical apparatus 2802; deriving optical density measurement information 2804; selecting the channels 2806, e.g., with or on which to perform analyses, such as by using an automated method (Patent 5, etc.) and/or manual selection techniques; performing motion artifact correction 2808, e.g., via performing wavelet analysis, etc.; optionally, performing further motion artifact detection 2810, e.g., via deep learning methodologies, AI, machine learning, etc.; excluding other stimuli not relevant 2812, e.g., via relation to temporally formatted data regarding the artificial reality context from the artificial reality headset, the computer, etc.; performing filtering 2814, e.g., band-pass filtering, etc.; and performing separation or similar processing of channels such as short channels 2816, e.g., channels denoting measurements from the skull as opposed to the brain.

With regard to aspects and nuances that may be performed in connection with systems and methods herein, such as, particularly, within functionality associated with the illustrative method 2800 of FIG. 34, various signal processing steps and features may be performed. In some embodiments, intensity data is converted to absorbance (OD). Additionally, channels may be motion-corrected using wavelet decomposition. According to certain implementations, the data may then be analyzed to detect any residual motion artifacts. In some specific implementations of artifact detection, artifacts may be flagged if the standard deviation changed by a factor >20 within a period of 2 seconds, approximately 2 seconds. Moreover, in such examples, if any artifact coincided with the period from, e.g., 5 seconds prior to a stimulus onset up to the length of that stimulation block, that stimulus was excluded from further processing. Additionally, in certain exemplary manipulation(s) of such data, data from the rotation stimuli may be resampled, e.g., to 1 Hz in some embodiments, to obtain a time point per position of the rotating wedge, whereas the eccentricity data may be analyzed at the full sampling rate, e.g., 5 Hz. Further, according to such exemplary manipulation(s), each channel may be band-pass filtered (e.g., using a fifth-order Butterworth filter, in one scenario) with low- and high-pass band of 0.025 and 0.5 Hz, respectively.

Turning next to the optodes and related configurations such as channel widths, source-detector separations, etc., short separation (SS) optodes, e.g. less than 15 mm in some embodiments, are mainly sensitive to superficial layers in the adult head, and they have been used routinely to remove the systemic interference present in longer separation channels. However, previous work has used a global regression approach, which seeks to remove the signal created by averaging all the SS channels in an array or a single SS regression approach that selects an SS channel that is physically closest to the mid-point of the channel in question. In contrast, certain implementations herein may utilize a local short separation (SS) regression approach, which may, e.g., comprise regressing the average of the signals derived from all the short channels that share the source or the detector of the channel in question. Indeed, this approach is especially beneficial in certain situations; for example, when the extracerebral contamination of a long-channel signal is primarily due to changes in haemoglobin concentrations directly beneath the source and detector, and hence the single short channel closest to the mid-point of that long channel is unlikely to be the optimal regressor. As such, to complete the processing to more advantageously, the averaged signal of the local SS channels is regressed out from long distance measurements, such as via a least squares technique. As a function of or based on such averaged signal, then, image reconstruction may then be conducted.

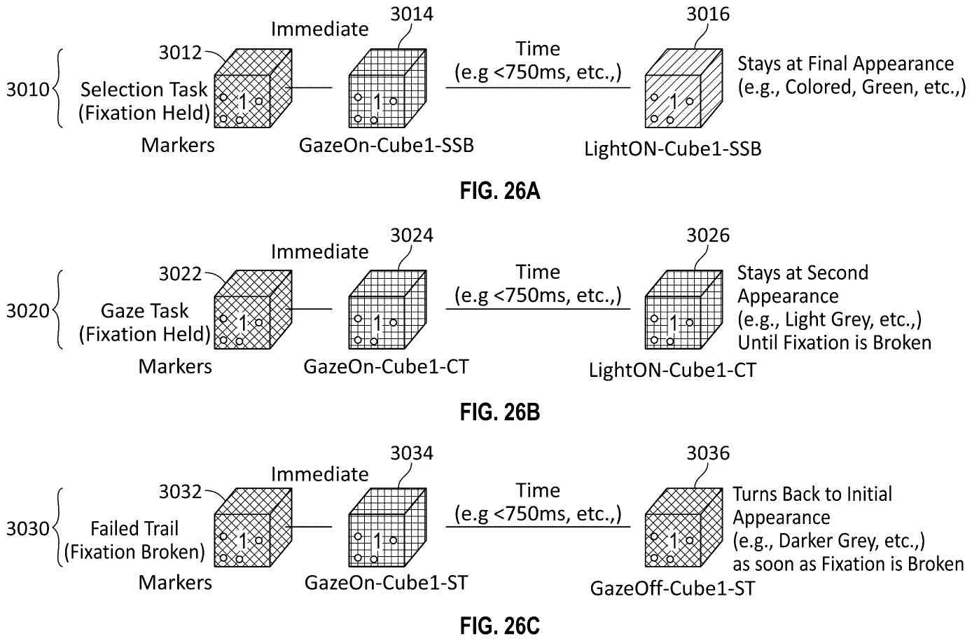

FIGS. 26A-26C depict various exemplary aspects of brain measurement(s) and processing involving high-density diffuse optical tomography (HT-DOT) arrays and associated signals, with FIGS. 35A-35B depicting exemplary measurements and signal strengths based on data from an illustrative HD-DOT array, and FIG. 35C depicting an exemplary comparison of brain activity images showing activity detected/provided via HD-DOT imaging versus fMRI imaging techniques, side-by-side, consistent with various exemplary aspects of one or more implementations of the disclosed technology. Referring to the drawings, FIGS. 35A-35B illustrate graphical information showing time domain signals, 2910 in FIG. 35A, and frequency domain signals, 2920 in FIG. 35B, generated based on illustrative data obtained via an exemplary HD-DOT array, such as changes in HbO₂ 2925, HbR 2926, HbT 2927, and blood-oxygen-level dependent (BOLD) signal 2928. In detecting/assessing such changes in Hb (Hemoglobin) and power/absorption, the disclosed technology may utilize HD-DOT arrays, measurements and associated features and functionality in brain-interfacing, in some embodiments, for example, by taking the signals and reconstructing an image in real-time representing the absorption metrics in the area of interest, and then using said image to classify brain activity using computer vision methodologies. FIG. 35A illustrates a representative or exemplary periodic response to the phase encoded design in a single voxel in the visual cortex of a single subject, graphed as a change in Hb measure on the y-axis 2912 over time along the x-axis 2914. FIG. 35B is a graph that illustrates changing such periodic response to a power spectrum in the frequency domain, depicted as power 2922 vs. frequency 2924 on the y and x axes, showing a strong peak at the stimulation (or rotation) frequency. As such, consistent with embodiments herein, mapping the phase at the stimulus frequency on the cortical surface of the participant reveals the retinotopic map in association with the visual cortex as recorded with HD-DOT and (separately) with fMRI, such as in FIG. 35C.

FIG. 26C depicts an illustrative comparison of brain activity images showing activity detected/provided via HD-DOT imaging (left image) versus fMRI imaging (right image). Referring to the representative images of FIG. 35C, such exemplary comparison may be generated, e.g., using a retinotopy paradigm to indicate that HD-DOT methods are reflective of brain activity in circumscribed brain areas, for example, areas 2962, 2964, 2966, 2968, 2970, 2972, and 2974.

Further, consistent with various aspects of the innovations herein, the brain regions, retinopathy and such associated signals and signal processing is applied to the brain-interfacing systems herein, e.g., where the retinotopy information (shown via illustrative retinopathy circle 2980) is generated, sent to, and utilized within the more complex artificial reality environments described herein. In connection with certain artificial reality implementations herein, various aspects of such retinopathy-enabled features and functionality may be employed as an example user experience whereby the brain activity can be visualised by the participant. It is important to note that a retinotopy paradigm is just one example of a user experience which can be leveraged to ascertain the capability and calibration of the HD-DOT system in real-time for a particular participant. In some embodiments, for example, the test features and functionality herein may be utilized to assay how the HD-DOT sensors are measuring subject/known brain activity, e.g., rotating the flickering wedge around the field of view may be done to result in brain activity activation in different areas of the participant visual cortex, so as to act as a calibration scheme. Here, for example, by showing a flickering stimulus, which is rotating to different locations in the virtual reality environment, the HD-DOT system may be calibrated to the specific user, because we can compare the brain activation location to where it would be expected to be from the knowledge of the locations of the corresponding visual areas in the brain. As such, consistent with aspects of the present designs, the spatial location of the stimulus may be encoded in the temporal phase of the response.

### Overall Implementations of the Disclosed Technology

According to the above such technology, systems and methods herein may be utilized to perform various brain state assessment features and functionality, and/or include aspects that detect and/or involve detection of haemodynamic signals and direct neuronal signals (fast optical signals) that both correspond to neural activity, simultaneously, among other things.

While the above disclosure sets forth certain illustrative examples, such as embodiments utilizing, involving and/or producing fast optical signal (FOS) and haemodynamic (e.g., NIRS, etc.) brain-computer interface features, the present disclosure encompasses multiple other potential arrangements and components that may be utilized to achieve the brain-interface innovations of the disclosed technology. Some other such alternative arrangements and/or components may include or involve other optical architectures that provide the desired results, signals, etc. (e.g., pick up NIRS and FOS simultaneously for brain-interfacing, etc.), while some such implementations may also enhance resolution and other metrics further.

Among other aspects, for example, implementations herein may utilize different optical sources than those set forth, above. Here, for example, such optical sources may include one or more of: semiconductor LEDs, superluminescent diodes or laser light sources with emission wavelengths principally, but not exclusively within ranges consistent with the near infrared wavelength and/or low water absorption loss window (e.g., 700-950 nm, etc.); non-semiconductor emitters; sources chosen to match other wavelength regions where losses and scattering are not prohibitive; here, e.g., in some embodiments, around 1060 nm and 1600 nm, inter alia; narrow linewidth (coherent) laser sources for interferometric measurements with coherence lengths long compared to the scattering path through the measurement material (here, e.g., (DFB) distributed feedback lasers, (DBR) distributed Bragg reflector lasers, vertical cavity surface emitting lasers (VCSEL) and/or narrow linewidth external cavity lasers; coherent wavelength swept sources (e.g., where the center wavelength of the laser can be swept rapidly at 10-200 KHz or faster without losing its coherence, etc.); multiwavelength sources where a single element of co packaged device emits a range of wavelengths; modulated sources (e.g., such as via direct modulation of the semiconductor current or another means, etc.); and pulsed laser sources (e.g., pulsed laser sources with pulses between picoseconds and microseconds, etc.), among others that meet sufficient/proscribed criteria herein.

Implementations herein may also utilize different optical detectors than those set forth, above. Here, for example, such optical detectors may include one or more of: semiconductor pin diodes; semiconductor avalanche detectors; semiconductor diodes arranged in a high gain configuration, such as transimpedance configuration(s), etc.; single-photon avalanche detectors (SPAD); 2-D detector camera arrays, such as those based on CMOS {complementary metal oxide semiconductor} or CCD {charge-coupled device} technologies, e.g., with pixel resolutions of 5×5 to 1000×1000; 2-D single photon avalanche detector (SPAD) array cameras, e.g., with pixel resolutions of 5×5 to 1000×1000; and photomultiplier detectors, among others that meet sufficient/proscribed criteria herein.

Implementations herein may also utilize different optical routing components than those set forth, above. Here, for example, such optical routing components may include one or more of: silica optical fibre routing using single mode, multi-mode, few mode, fibre bundles or crystal fibres; polymer optical fibre routing; polymer waveguide routing; planar optical waveguide routing; slab waveguide/planar routing; free space routing using lenses, micro optics or diffractive elements; and wavelength selective or partial mirrors for light manipulation (e.g. diffractive or holographic elements, etc.), among others that meet sufficient/proscribed criteria herein.

Implementations herein may also utilize other different optical and/or computing elements than those set forth, above. Here, for example, such other optical/computing elements may include one or more of: interferometric, coherent, holographic optical detection elements and/or schemes; interferometric, coherent, and/or holographic lock-in detection schemes, e.g., where a separate reference and source light signal are separated and later combined; lock in detection elements and/or schemes; lock in detection applied to a frequency domain (FD) NIRS; detection of speckle for diffuse correlation spectroscopy to track tissue change, blood flow, etc. using single detectors or preferably 2-D detector arrays; interferometric, coherent, holographic system(s), elements and/or schemes where a wavelength swept laser is used to generate a changing interference patter which can be analyzed; interferometric, coherent, holographic system where interference is detected on, e.g., a 2-D detector, camera array, etc.; interferometric, coherent, holographic system where interference is detected on a single detector; controllable routing optical medium such as a liquid crystal; and fast (electronics) decorrelator to implement diffuse decorrelation spectroscopy, among others that meet sufficient/proscribed criteria herein.

Implementations herein may also utilize other different optical schemes than those set forth, above. Here, for example, such other optical schemes may include one or more of: interferometric, coherent, and/or holographic schemes; diffuse decorrelation spectroscopy via speckle detection; FD-NIRS; and/or diffuse decorrelation spectroscopy combined with TD-NIRS or other variants, among others that meet sufficient/proscribed criteria herein.

Implementations herein may also utilize other multichannel features and/or capabilities than those set forth, above. Here, for example, such other multichannel features and/or capabilities may include one or more of: the sharing of a single light source across multiple channels; the sharing of a single detector (or detector array) across multiple channels; the use of a 2-D detector array to simultaneously receive the signal from multiple channels; multiplexing of light sources via direct switching or by using “fast” attenuators or switches; multiplexing of detector channels on to a single detector (or detector array) via by using “fast” attenuators or switches in the routing circuit; distinguishing different channels/multiplexing by using different wavelengths of optical source; and distinguishing different channels/multiplexing by modulating the optical sources differently, among others that meet sufficient/proscribed criteria herein.

As disclosed herein, implementations and features of the present inventions may be implemented through computer-hardware, software and/or firmware. For example, the systems and methods disclosed herein may be embodied in various forms including, for example, one or more data processors, such as computer(s), server(s), and the like, and may also include or access at least one database, digital electronic circuitry, firmware, software, or in combinations of them. Further, while some of the disclosed implementations describe specific (e.g., hardware, etc.) components, systems, and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the inventions or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the inventions, or it may be more convenient to construct a specialized apparatus or system to perform the required methods and techniques.

In the present description, the terms component, module, device, etc. may refer to any type of logical or functional device, process or blocks that may be implemented in a variety of ways. For example, the functions of various blocks can be combined with one another and/or distributed into any other number of modules. Each module can be implemented as a software program stored on a tangible memory (e.g., random access memory, read only memory, CD-ROM memory, hard disk drive) within or associated with the computing elements, sensors, receivers, etc. disclosed above, e.g., to be read by a processing unit to implement the functions of the innovations herein. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy logic, neural networks, other AI (Artificial Intelligence) or machine learning systems, quantum devices, and hybrids of any of the above device types.

It should also be noted that various logic and/or features disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in tangible various forms (e.g., optical, magnetic or semiconductor storage media), though do not encompass transitory media.

Other implementations of the inventions will be apparent to those skilled in the art from consideration of the specification and practice of the innovations disclosed herein. It is intended that the specification and examples be considered as exemplary only, with a true scope and spirit of the inventions being indicated by the present disclosure and various associated principles of related patent doctrine.

As one overview of aspects of the disclosed technology, systems, methods and wearable devices associated with mind/brain-computer interfaces are disclosed. Embodiments herein include features related to one or more of optical-based brain signal acquisition, decoding modalities, encoding modalities, brain-computer interfacing, AR/VR content interaction, brain state assessment, signal to noise ration enhancement, and/or motion artefact reduction, among other features set forth herein. Certain implementations may include or involve processes of collecting and processing brain activity data, such as those associated with the use of a brain-computer interface that enables, for example, decoding and/or encoding a user's brain functioning, neural activities, and/or activity patterns associated with thoughts, including sensory-based thoughts. Further, the present systems and methods may be configured to leverage brain-computer interface and/or non-invasive wearable device aspects to provide enhanced user interactions for next-generation wearable devices, controllers, and/or other computing components based on the human thoughts, brain signals, and/or mind activity that are detected and processed.

1. (canceled)

2. A computer-implemented method of processing data associated with a brain computer interface (BCI) system and/or an artificial reality system, the method comprising:
acquiring and/or processing, via the BCI system, a user's brain activity using at least one neuro-assessment technique, wherein the user's brain activity is recorded as first data, which may be temporally formatted, may include time-stamped samples of brain activity, etc.;
tracking, via the artificial reality system, the user's movements and/or interactions in a virtual environment, to acquire or obtain second data therefrom, wherein the second data may be temporally formatted and may include time-stamped samples of the user's motion, position, orientation, and/or actions in the virtual environment;
performing processing, via at least one processor, of the first data, the second data, at least one first data stream based on the first data, and/or at least one second data stream based on the second data to determine an emotional state of the user;
determining, as a function of the emotional state of the user, different and/or updated virtual content to feedback to the user; and
displaying to and/or immersing the user with the different and/or updated virtual content in the artificial reality environment.

3. The method of claim 2, wherein the performing processing includes one or both of:
initially processing the first data steam and the second data stream together into sequence data, such as by performing attention-based and/or vector determination processing to, yield weighted and/or transformed data suitable for expression in one or more vectors, matrices, or other data structures suitable for assembly in a form of a sequence of features; and/or
processing, by the at least one processor, the sequence data to generate or predict an emotional state of the user.

4. The method of claim 3, wherein the step of processing the sequence data to formulate/predict an emotional state of the user includes:
(a1) processing the sequence data via a sequence-to-vector model, e.g., a model that processes the sequence and produces a fixed-size representation that yields a representation of the emotional state, and (a2) feeding the representation into a classifier, e.g., logistic regression, neural network, et., to predict the emotional state; and/or
(b1) processing the sequence data via a sequence-to-vector model, e.g., a model that processes the sequence and produces a fixed-size representation that yields a representation of the emotional state, and (b2) processing the representation via an attention mechanism to predict the emotional state.

5. The method of claim 4, wherein the performing processing comprises:
processing a sequence of inputs; and
generating a fixed-size output vector that summarizes the sequence and may be utilized to represent the user's emotional state.

6. The method of claim 5, further comprising utilizing a recurrent neural network (RNN) to implement a sequence-to-vector model with an attention mechanism in the performing processing, wherein, in one embodiment, the RNN takes an input vector and updated its hidden state according to one or more equations including:
$$h\_t = f ( Wx\_t + Uh\_ \{ t - 1 \} ) ;$$
with an output of the RNN at each time-step t then computed as:
$$y\_t = g ( Vh\_t ) ;$$
and
to incorporate an attention mechanism into this model, a set of attention weights alpha_t are introduced that determine how much weight to place on each time-step when computing the final output, with the attention weights computed as follows:
$$alpha\_t = softmax ( w \hat{} T tanh ( Uh\_ \{ t - 1 \} + Vh\_t ) )$$
where w is a weight vector that is learned during training, and the softmax function ensures that the attention weights sum to 1;
wherein a final output vector, which summarizes the sequence entirely, is then computed as a weighted sum of the RNN outputs, where the attention weights determine the weights of the sum:
$$y = sum\_t alpha\_t y\_t .$$

7. The method of claim 6, wherein the second data includes eye-tracking data of the user from the artificial reality environment.

8. The method of claim 7, further comprising:
synchronizing information from the first data, or a first data stream associated therewith, and the second data, or a second stream associated therewith, to analyze event-related brain data occurring in temporal conjunction with occurrences and/or activity of an artificial reality experience in the artificial reality environment.

9. The method of claim 8, wherein the first data stream and the second data stream are each preprocessed (2006) via separate signal processing pipelines, such as a first signal processing pipeline and a second signal processing pipeline, respectively, prior to the performing processing step.

10. The method of claim 9, further comprising:
formatting, combining and/or pre-processing the first data and/or a first stream of the first data stream prior to the performing processing step, for example, by utilization of decoder devices, methods and/or processing, such as a decoder comprising a spatial feature model, a temporal feature model and a classifier.

11. The method of claim 10, wherein the user's brain activity is recorded, via the BCI system, in real-time, and/or wherein the at least one neuro-assessment technique includes one or more of electroencephalography (EEG), functional magnetic resonance imaging (fMRI), near-infrared spectroscopy (NIRS), functional near-infrared spectroscopy (fNIRS), FOS imaging, and/or other such known techniques.

12. The method of claim 11, wherein the first data and the second data are analyzed separately in real-time, such as by siphoning off the real-time data to the relevant signal processing pipeline.

13. The method of claim 12, wherein one or both:
first raw signal data of the first data, such as EEG data, is preprocessed to remove artifacts, filtered, and segmented into epochs that correspond to different phases of the task or stimulus; and/or
second raw signal data of the first data, such as NIRS data, is preprocessed to remove artifacts and then analyzed to determine changes in oxygenation and/or blood flow in different regions of the brain.

14. The method of claim 13, wherein one or more locations of sensors that obtain the second raw (e.g., NIRS, etc) data are utilized to guide analysis of the first raw signal (e.g., EEG, etc) data by focusing on brain regions that show significant changes in oxygenation or blood flow; and/or
wherein, once such pre-processed data reaches an attention-based sequence to vector model, both pre-processed streams of the first raw data (e.g., EEG datastream, etc) and the second raw data (e.g., NIRS datastream, etc) as inputs to modeling, such as by being combined on level of a machine learning step by taking both as inputs thereto, which thereby provides a more comprehensive view of brain activity.

15. The method of claim 14, further comprising:
aligning, comparing and/or further processing the first (BCI system) data with the second data to establish which motions, movement, position, orientation, action and/or activities of the user in the virtual environment correspond to associated brain state measurements and/or signals detected via the BCI system.

16. The method of claim 15, further comprising:
utilizing a decoder to perform processing related to assessing and/or quantifying the emotional state or a brain state of the user, wherein the decoder is comprised of one or more of:
a spatial feature model that may include and/or utilize, e.g., a convolutional neural network (CNN) to extract spatial information from the first data;
a temporal feature model that may include and/or utilize, e.g., one or more long short-term memory (LSTM) network layers to extract temporal information, and/or a sequence-to-sequence model such as an LSTM to explore temporal information of the first (brain) data; and/or
a classifier, which may include or involve, e.g.: a Softmax layer that transforms channel importance to a probability distribution or comparable mathematical expression; and/or one or more alternative functions that can be used in place of a softmax function.

17.-18. (canceled)

19. A computer-implemented method for integrated processing of data associated with a brain computer interface (BCI) system and/or an artificial reality system, the method comprising:
acquiring and/or processing, via the BCI system, a user's brain activity using at least one neuroimaging technique, to yield first data regarding the user's brain activity, wherein the first data may be temporally formatted, may includes time-stamped samples of brain activity, etc.;
tracking and/or monitoring, via the artificial reality system, the user's movements and/or interactions in an artificial reality environment, to yield second data, wherein the second data may be temporally formatted, may include time-stamped samples of the user's position, orientation, and/or actions in the virtual environment, etc.;
performing processing, via at least one processor, to combine, synchronize and/or integrate a temporally formatted first data stream associated with the first data with a temporally formatted second data stream associated with the second data;
processing, by the at least one processor, synchronized information from the first data stream and the second data stream to analyze event-related brain data occurring in temporal conjunction with occurrences and/or activity of a VR experience in the virtual environment;
detecting when the user performs a specific action in the virtual environment; and
analyzing brain activity of the user corresponding in time to the specific action to identify patterns and/or changes in the brain activity associated with the specific action.

20. The method of claim 19, wherein the user's brain activity is recorded, via the BCI system, in real-time, and/or wherein the at least one neuroimaging technique includes one or more of electroencephalography (EEG), functional magnetic resonance imaging (fMRI), and/or other known techniques.

21. The method of claim 20, wherein the performing processing to combine, synchronize and/or integrate the temporally formatted data streams includes synchronizing timestamps of the first and the second data streams, and/or aligning events in the virtual environment with corresponding brain activity, such as by temporally formatted the first and the second data streams relative to the events occurring in the artificial reality experience.

22. The method of claim 21, further comprising:
providing, within or via the artificial reality environment, specific stimuli and/or challenges that elicit certain brain responses associated with a specific training or rehabilitation program;
analyzing the brain activity corresponding to the stimuli and/or challenges to provide feedback to the user and/or adjust the VR experience to optimize the training or rehabilitation program, such as a neurorehabilitation or cognitive training program.

23. The method of claim 22, wherein the at least one processor utilizes a common time reference, such as a system clock, to ensure that the data streams are synchronized.

24.-50. (canceled)
